(19) United States
(12) Patent Application Publication
(10) Pub. No.: US 2015/0164105 A1
(43) Pub. Date: Jun. 18, 2015

(54) SLURRY BEVERAGE AND CONTAINER THEREFOR

(71) Applicants: Brett Saul Peskin, Miami, FL (US); John Paul Huff, III, Shaker Heights, OH (US); Uri Gregory Magaram, Shaker Heights, OH (US)

(72) Inventors: Brett Saul Peskin, Miami, FL (US); John Paul Huff, III, Shaker Heights, OH (US); Uri Gregory Magaram, Shaker Heights, OH (US)

(21) Appl. No.: 14/572,292

(22) Filed: Dec. 16, 2014

Related U.S. Application Data
(60) Provisional application No. 61/916,335, filed on Dec. 16, 2013.

(51) Int. Cl. A23G 9/04; B65D 25/04; A23G 9/28

(52) U.S. Cl. CPC A23G 9/045; A23G 9/283; B65D 25/04

(57) ABSTRACT

An exemplary multi-color slurry beverage (10) comprises a cup (20) which defines a container space (30) and a separator (40) which separates the container space (30) into a first compartment (31) and a second compartment (32) extending from the floor of the cup (20) to its top rim. In exemplary embodiments, the separator is selectively insertable into and removable from the container space (30). In exemplary embodiments, (40) a first semi-frozen slurry (51) having a first color fills the first compartment (31) and a second semi-frozen slurry (52) having a second color fills the second compartment (32).

### CROSS-REFERENCE TO RELATED APPLICATION

This application is a U.S. Non-Provisional Patent Application which claims priority to U.S. Provisional Patent Application Ser. No. 61/916,335, filed on Dec. 16, 2013 and titled “MULTI-COLOR SLURRY BEVERAGE,” which is hereby incorporated by reference in its entirety.

### TECHNICAL FIELD

The present invention relates generally to consumable semi-frozen slurries and containers for consumable semi-frozen slurries, such as cups, and cups with a lid and a straw for drinking from the cup.

### BACKGROUND OF THE INVENTION

A slurry beverage (e.g., a slushie) can comprise a cup, a container spaced defined by the cup, and semi-frozen slurry within the container space. The slurry is flowable whereby it can be dispensed from a spout and it is drinkable through a straw. Semi-frozen slurries are typically offered in a variety of different colors which are selectively dispensable from one or more spouts into a variety of different types of containers for consumption.

### SUMMARY

A multi-color slurry beverage is provided wherein different colored semi-frozen slurries each occupy a different vertical compartment within a cup's container space.

In one exemplary embodiment, a slurry beverage container comprises a cup which defines a container space and a separator which separates the container space into a first compartment and a second compartment extending from the floor of the cup to its top rim.

In an additional exemplary embodiment, a slurry beverage container comprises a cup which defines a container space and a separator which is selectively insertable into and removable from the container space. The separator separates the container space into a first compartment and a second compartment extending from the floor of the cup to its top rim.

In an additional exemplary embodiment, a multi-color slurry beverage comprises a slurry beverage container that includes a cup which defines a container space and a separator which separates the container space into a first compartment and a second compartment extending from the floor of the cup to its top rim. A first semi-frozen slurry having a first color fills the first compartment and a second semi-frozen slurry having a second color fills the second compartment.

### BRIEF DESCRIPTION OF THE DRAWINGS

The accompanying drawings incorporated herein and forming a part of the specification, illustrate several embodiments and together with the description serve to explain certain principles of the invention.

FIGS. 1A-1F show an exemplary embodiment of a multi-color slurry beverage having two compartments and related method steps;

FIGS. 2A-2F show an exemplary embodiment of a multi-color slurry beverage having two compartments and related method steps;

FIGS. 3A-3F show an exemplary embodiment of a multi-color slurry beverage having two compartments and related method steps;

FIGS. 4A-4F show an exemplary embodiment of a multi-color slurry beverage having two compartments and related method steps;

FIGS. 5A-5E show exemplary embodiments of multi-color slurry beverages being enjoyed;

FIGS. 6A-6F show exemplary embodiments of multi-color slurry beverages being enjoyed;

FIGS. 7A-7F show exemplary embodiments of multi-color slurry beverages being enjoyed;

FIGS. 8A-8G show exemplary embodiments of multi-color slurry beverages being enjoyed;

FIGS. 9A-9L show various exemplary embodiments of cups, lids, and corresponding separators;

FIGS. 10A-10F show an exemplary embodiment of a topped-off multi-color slurry beverage and related method steps;

FIGS. 11A-11F show an exemplary embodiment of a topped-off multi-color slurry beverage and related method steps;

FIGS. 13A-13D show exemplary embodiments of multi-color slurry beverages having four compartments;

FIGS. 14A-14D show exemplary embodiments of multi-color slurry beverages having four compartments;

FIGS. 15A-15D show exemplary embodiments of multi-color slurry beverages having four compartments;

FIGS. 16A-16D show exemplary embodiments of multi-color slurry beverages having four compartments;

FIGS. 17A-17D show exemplary embodiments of multi-color slurry beverages having four compartments;

FIGS. 18A-18D show exemplary embodiments of multi-color slurry beverages having four compartments;

FIGS. 19A-19D show exemplary embodiments of multi-color slurry beverages having four compartments;

FIGS. 20A-20D show exemplary embodiments of multi-color slurry beverages having four compartments;

FIGS. 21A-21D show exemplary embodiments of multi-color slurry beverages having four compartments;

FIGS. 22A-22D show exemplary embodiments of multi-color slurry beverages having four compartments;

FIGS. 23A-23D show exemplary embodiments of multi-color slurry beverages having four compartments;

FIGS. 24A-24D show exemplary embodiments of multi-color slurry beverages having four compartments;

FIGS. 25A-25D show exemplary embodiments of multi-color slurry beverages having four compartments;

FIGS. 26A-26D show exemplary embodiments of multi-color slurry beverages having four compartments;

FIGS. 27A-27D show exemplary embodiments of multi-color slurry beverages having four compartments; and

FIGS. 28A-28D show exemplary embodiments of multi-color slurry beverages having four compartments.

### DETAILED DESCRIPTION

The present invention will now be described with occasional reference to specific embodiments of the invention. This invention may, however, be embodied in different forms and should not be construed as limited to the embodiments set forth herein. Rather, these embodiments are provided so that this disclosure will fully convey the scope of the invention to those skilled in the art and are not intended to limit the scope of the invention in any way.

Also, while the detailed exemplary embodiments described in the specification and illustrated in the drawings relate to multi-color slurry beverages described as being useful in connection with semi-frozen slurries, it should be understood that the beverage containers and methods of filling said beverage containers described herein may be used in connection with any beverage, such as, for example, soda or pop, fruit or vegetable juices, sports drinks, alcoholic beverages, flavored water, coffee, tea, or the like.

Except as otherwise specifically defined herein, all terms used herein have the same meaning as commonly understood by one of ordinary skill in the art to which this invention belongs. The terminology used in the description of the invention herein is for describing particular embodiments only, and is not intended to be limiting of the invention. As used in the description of the invention, the singular forms “a,” “an,” and “the” are intended to include the plural forms as well, unless the context clearly indicates otherwise.

Unless otherwise indicated, all numbers expressing quantities, properties, and so forth as used in the specification are to be understood as being modified in all instances by the term “about.” Accordingly, unless otherwise indicated, the numerical properties set forth in the following specification are approximations that may vary depending on the desired properties sought to be obtained in embodiments of the present invention. Notwithstanding that the numerical ranges and parameters setting forth the broad scope of the invention are approximations, the numerical values to the extent that such are set forth in the specific examples are reported as precisely as possible. Any numerical values, however, inherently contain certain errors necessarily resulting from error found in their respective measurements.

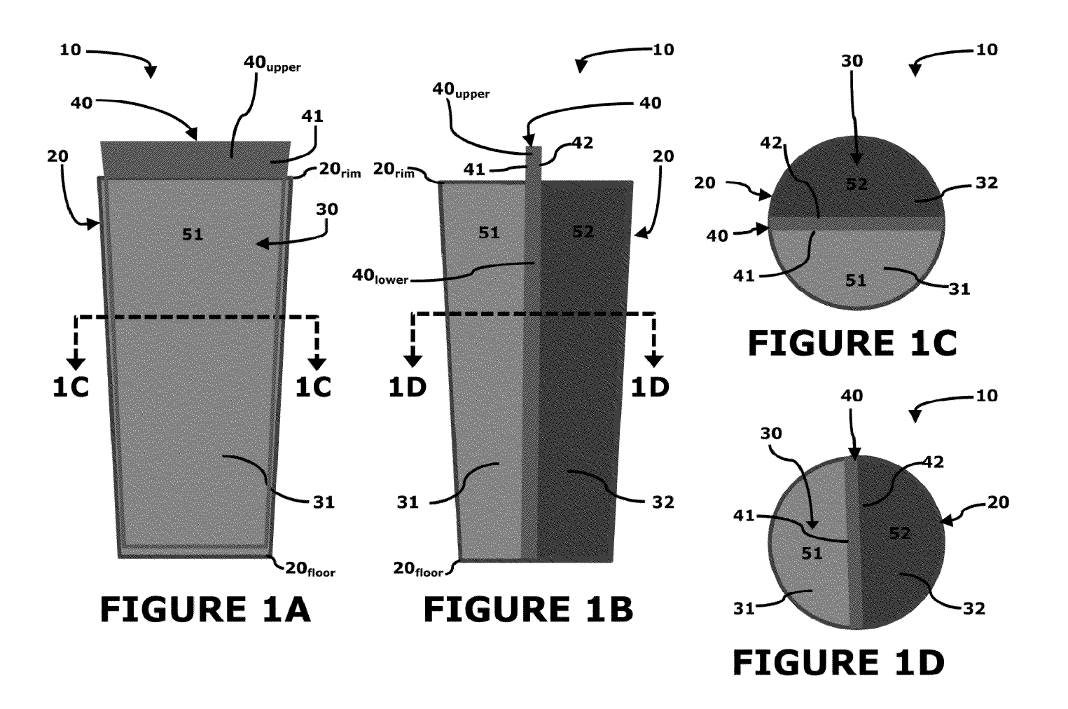

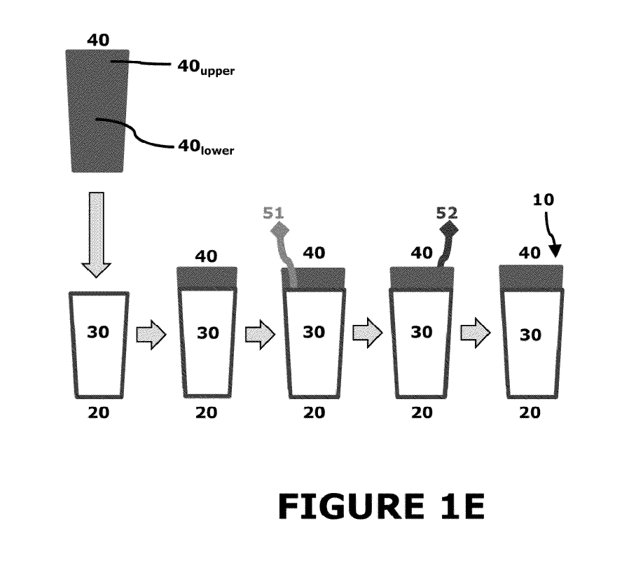

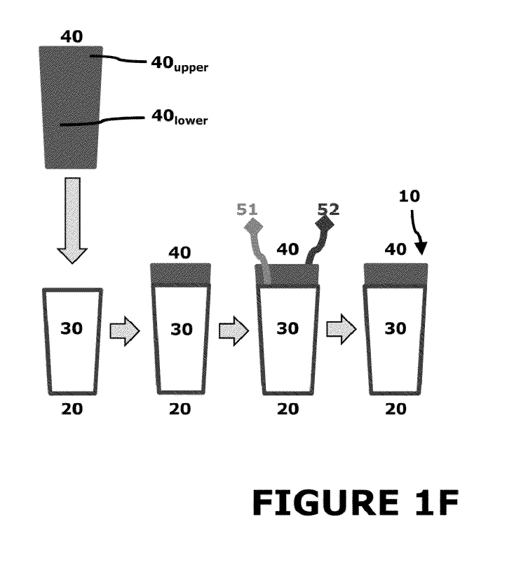

Referring now to the drawings, and initially to FIGS. 1A-1D, a first embodiment of a multi-color slurry beverage 10 is shown. The illustrated embodiment of beverage 10 comprises a cup 20, a container space 30 defined by the cup 20, and a separator 40 inserted into the container space 30. The separator 40 separates the container space 30 into a first compartment 31 and a second compartment 32. A first semi-frozen slurry 51 occupies the first compartment 31 and a second semi-frozen slurry 52 occupies the second compartment 32. The slurries 51-52 are of different visually distinguishable colors.

The cup 20 can have a generally cylindrical shape with a circular floor 20 floor and a circular top rim 20ᵣᵢₘ. It can have a conventional construction and of a size commonly used by beverage-serving establishments. For example, the cup 20 can be dimensioned to accommodate 8 ounces, 12 ounces, 16 ounces, 18 ounces, or 20 ounces. That being said, much larger “giant” sizes (e.g., 32 ounces, 48 ounces, etc.) are also often popular with slurry often products. The cup can also have any cross-sectional shape, such as, for example, an oval, square, hexagon, octagon or the like.

If the cup 20 is intended to be disposable and/or a single-use item, constructions including food grade insulating foam (e.g., styrofoam) are often preferred. A disposable cup 20 made of other materials (e.g., treated paper, paperboard, plastics, paper-plastic laminates, paper-foil composites, and/or other fluid-holding food grade materials) is buildable and may be beneficial. If the cup 20 is intended to be reused, it can be made of glass, ceramic, metal, or other compatible cup materials. It should be understood that in additional embodiments, any suitable material may be used.

The container space 30 is defined by the cup 20 and thus can also have a generally cylindrical shape. The compartments 31-32 can extend vertically from the cup's floor 20ₙₒₒᵣ to at least its top rim 20ᵣᵢₘ and they can be of approximately the same dimensions. Thus, with a cylindrical cup 20 and/or space 30, the compartments 31-32 can each be semi-cylindrical. It should be understood that container space can have any shape as defined by the cup, and that compartments in the container space can be fractions of any shape.

The separator 40 can comprise a sheet-like structure having a first side 41 defining an inner wall of the first compartment 31 and a second side 42 defining an inner wall of the second compartment 32. A lower portion 40_{lower} of the separator can have a perimeter profile which follows the cup's inner contour along its bottom and side edges. An upper portion 40ᵤₚₚₑᵣ of the separator 40 can extend above the cup's top rim 20ᵣᵢₘ. However, a separator 40 without an upper portion is obtainable and may be an option.

The separator 40 is formed separately from the cup 30 and is able to support itself in an upright position. The separator 40 can be made from a food-grade polymeric material, such as polypropylene, polyethylene terephthalate (PET) based polyesters, polystyrenes, and/or blends thereof. The separator 40 can be rigid enough to resist compartment collapse into an empty void during early filling steps. This rigidity can be accomplished by material selection and/or thickness choices. The separator may also be stiffened by changing its profile through the addition of ridges, or may be made of a suitably strong and flexible material to stretch but not collapse while filling.

When the beverage 10 is a slushie, the slurries 51-52 can comprise a fine dispersion of ice particles, sweeteners, food coloring, and flavoring. In many instances, the sugars, food coloring, and flavoring will be contained in syrup which is intermixed in some manner with ice particles prior to slurry introduction into the cup's container space 30.

The viscosity of the slurries 51-52 should be such that they are drinkable through a straw (such as straw 70, introduced below). As discussed previously, while the detailed exemplary embodiments are described herein as being useful in connection with semi-frozen slurries, it should be understood that the beverage containers and methods of filling said beverage containers described herein may be used in connection with any beverage, such as, for example, soda or pop, fruit or vegetable juices, sports drinks, alcoholic beverages, flavored water, coffee, tea, or the like.

As was mentioned above, in the illustrated embodiment, the first semi-frozen slurry 51 has a first color and the second semi-frozen slurry 52 has a second color, these colors being visually distinguishable from each other. These colors can be red, pink, orange, yellow, green, blue, purple, brown, grey, black, white, and/or a mixture thereof. Varying shades of the same color (e.g., sky blue and navy blue, army green and lime green, khaki brown and bark brown, etc.) can also constitute different colors if they are visually distinguishable from each other. In yet additional embodiments, the first semi-frozen slurry 51 and the second semi-frozen slurry 52 may have the same color.

The semi-frozen slurries 51-52 can also have different flavors thanks to the flavorings incorporated in the slurry mixture. Some possible flavorings can include almond, amaretto, apple, apricot, arctic bramble, banana, banana split, barberry, beer, bergamot, bilberry, black currant, blackberry, bloody Mary, blueberry, boysenberry, brandy, brown sugar, butterscotch, cake batter, cantaloupe, caramel, carob, cashew apple, cassis, champagne, cherimoya, cherry, chocolate, cider, cinnamon, citrus, cloudberry, cocoa, coconut, coffee, cognac, cola, cowberry, cranberry, cream, cucumber, currant, custard apple, date, donut, durian, eggnog, elderberry, espresso, fig, fudge, gin, ginger, ginger ale, gooseberry, grape, grapefruit, guava, gumdrop, hawthorn, hazelnut, honey, honeydew melon, ice cream, jackfruit, jujube, kaki, kiwi, kumquat, lemon, licorice, macadamia, lime, loquat, malted milk, mango, marshmallow, margarita, melon, molasses, mountain papaya, mulberry, musk melon, nectarine, nougat, orange, papaya, peach, peanut, peanut butter, pear, pecan, peppermint, persimmon, pineapple, pizza, plantain, plum, pomegranate, popcorn, prickly pear, prune, pumpkin, punch, quince, raisin, raspberry, red currant, root beer, rum, sapodilla, sea buckthorn, spearmint, spice, squash, star apple, strawberry, tamarind, tangerine, tea, toffee, tomato, vanilla, vodka, walnut, watermelon, whiskey, wine, wintergreen, wood apple and yogurt. It should be understood that any edible flavoring compound can be incorporated into the slurry mixture.

Additionally or alternatively, the semi-frozen slurries 51-52 can incorporate commercially established sodas (e.g., Coca-Cola, Pepsi Cola, Mountain Dew, Schweppes, etc.), fruit drinks (e.g., Country Time Lemonade, Tropicana Orange Juice, Welch's Grape Juice, etc.), beers (e.g. Budweiser, Corona, Amstel, etc.), and/or coffees (e.g., Starbucks, Folgers, Seattle's Best, etc.). All of the names mentioned in parenthesis in this paragraph are registered trademarks of companies unaffiliated with the applicants.

The flavors can (but need not) correspond to the colors of the semi-frozen slurries. For example, a pink-colored slurry can have a watermelon flavor, a red-colored slurry can have a strawberry flavor, an orange-colored slurry can have a tangerine flavor, a yellow-colored slurry can have a banana flavor, a green-colored slurry can have a lime flavor, a blue-colored slurry can have a blueberry flavor, a purple-colored slurry can have a grape flavor, a brown-colored slurry can have a cinnamon flavor, a grey-colored slurry can have a vodka flavor, a black-colored slurry can have a licorice flavor, and/or white-colored slurry can have a vanilla flavor.

As shown in FIGS. 1E-1F, the multi-colored slurry beverage 10 can be made by a method comprising the step of inserting the separator 40 into the container space 30 wherein it supports itself in an upright position. The method then includes the steps of filling the first compartment 31 with the first semi-frozen slurry 51, and filling the second compartment 32 with the second semi-frozen slurry 52. The filling steps can be performed sequentially as shown in FIG. 1E, or they can be performed simultaneously as shown in FIG. 1F.

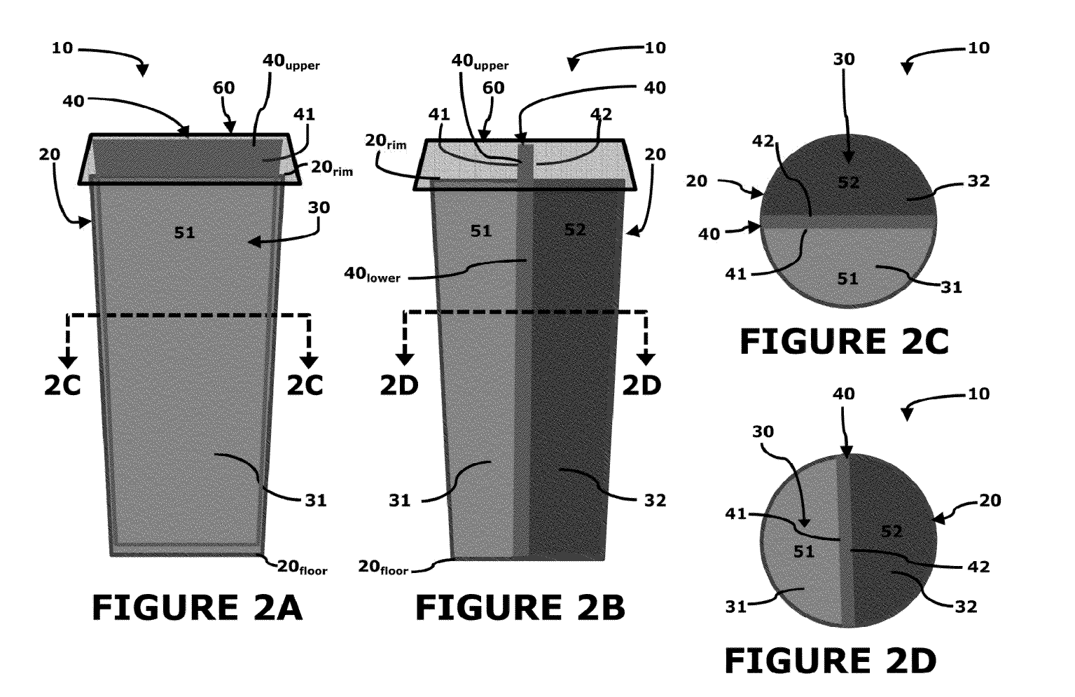

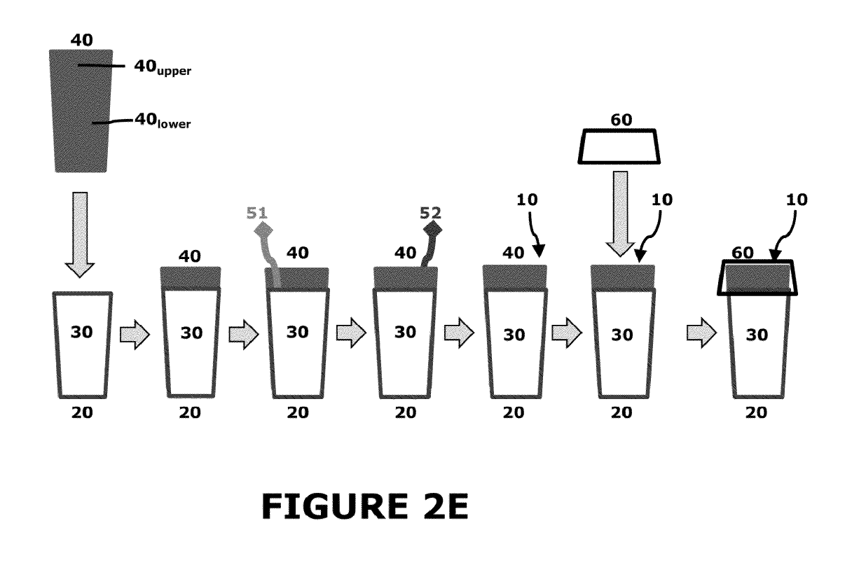

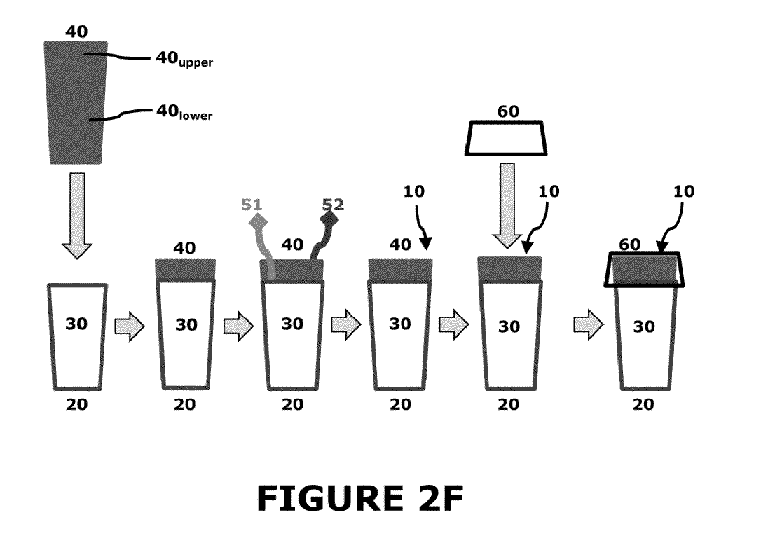

Referring to FIGS. 2A-2D, a second exemplary embodiment of the present invention is illustrated. In this embodiment, the multi-color slurry beverage 10 further comprises a lid 60 adapted to engage the top rim 20ᵣᵢₘ of the cup 20. As shown in FIGS. 2E-2F, the lid 60 can be placed on the cup 20 after the filling steps. If the separator 40 includes an upper portion 40ᵤₚₚₑᵣ which extends above the top rim 20ᵣᵢₘ of the cup 20, it can be sized and shaped to accommodate the desired lid 60. It should be understood that the lid may be formed of any suitable material, and may be the same material as the cup or separator, or may be formed of an altogether different material.

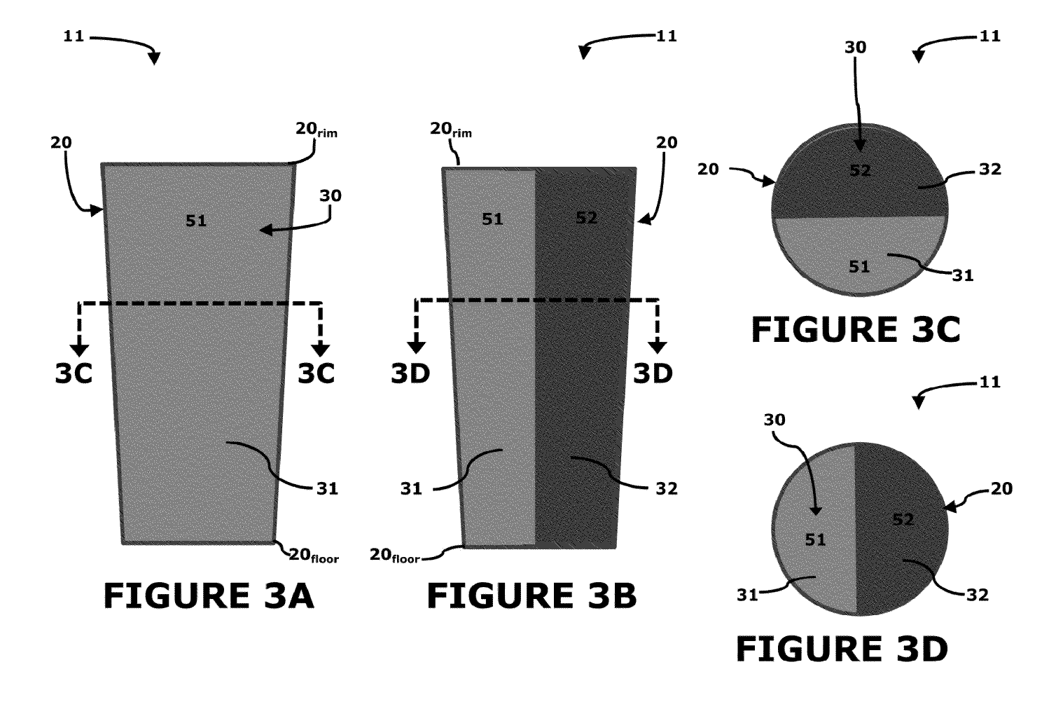

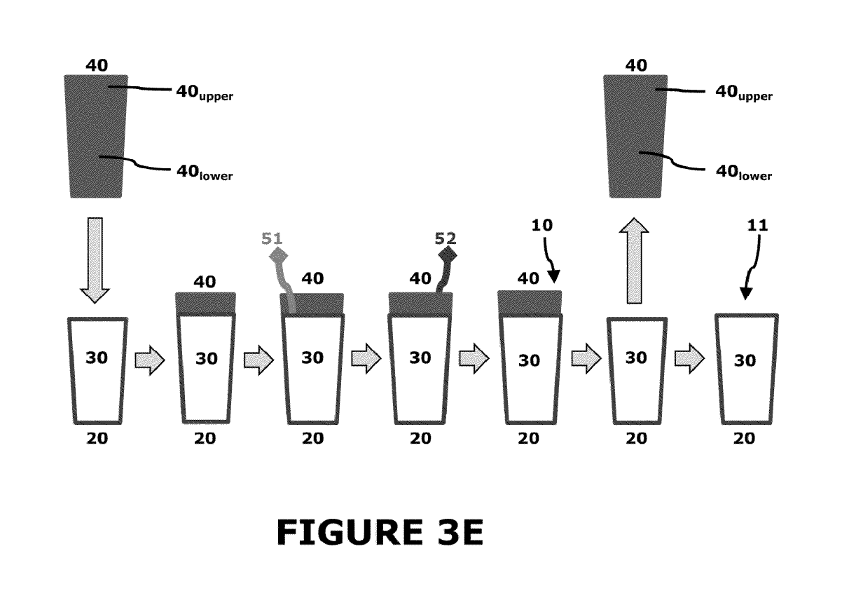

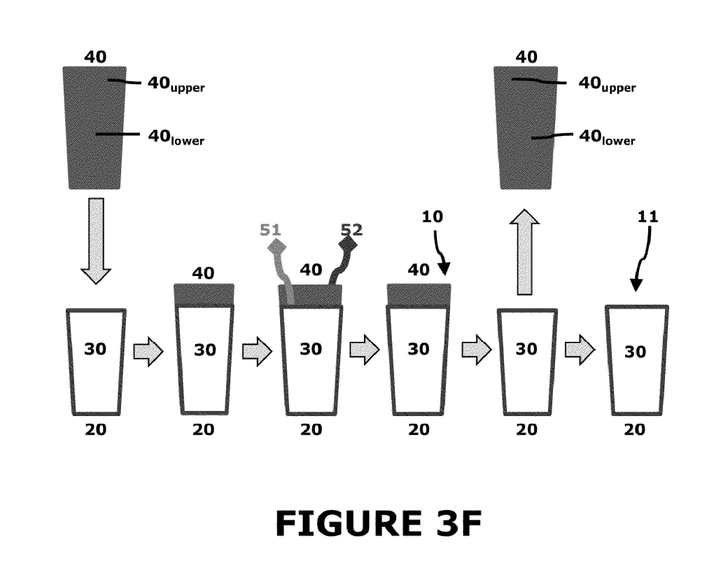

Referring to FIGS. 3A-3D, a third exemplary embodiment of the present invention is illustrated. In this embodiment, the multi-color frozen beverage 11 can be made by removing the separator 40 from the container space 30. With this removal, the first semi-frozen slurry 51 still substantially occupies only the first compartment 31 and the second semi-frozen slurry 52 still substantially occupies only the second compartment 32. It should be understood that the first and second semi-frozen slurries 51, 52 may mix if disturbed mechanically, such as by shaking or stirring, or if one or the other slurry is consumed more quickly than the other by the user.

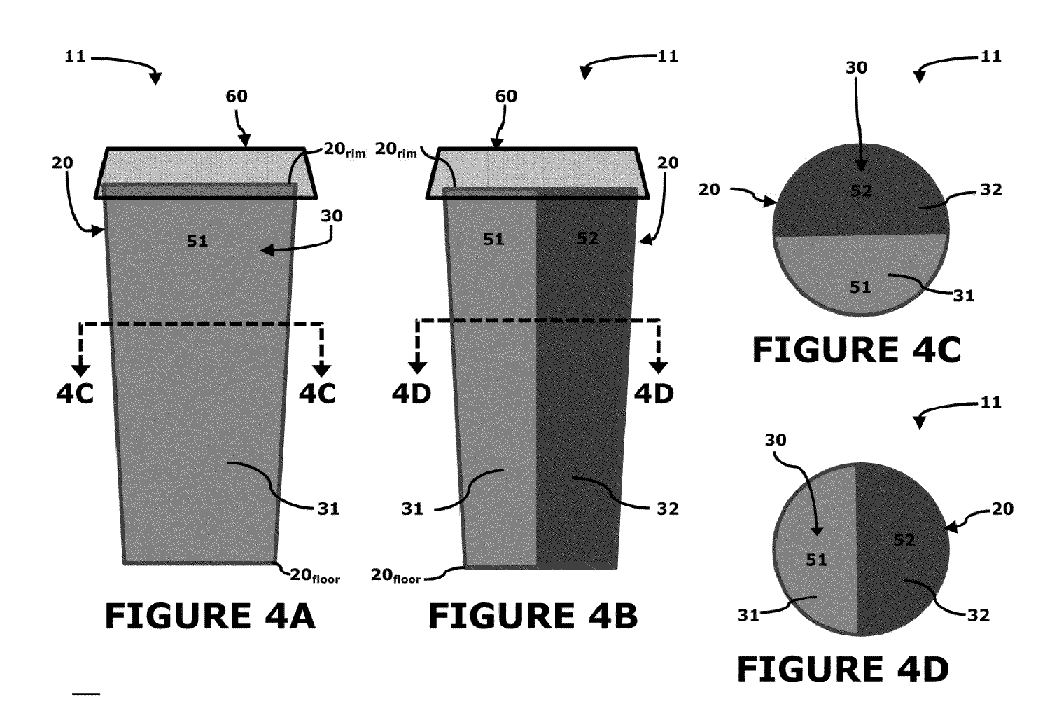

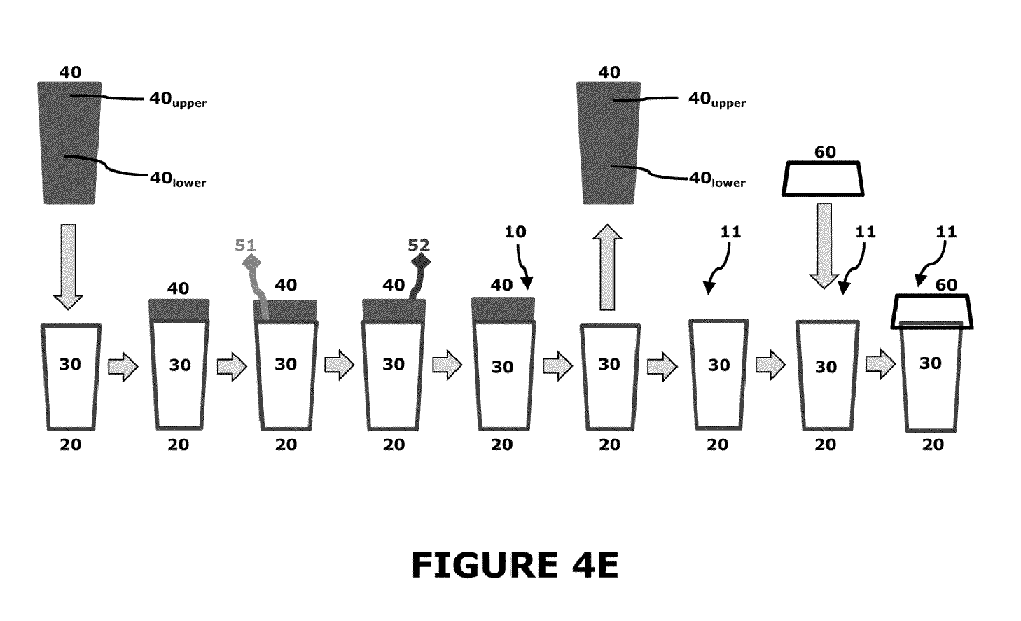

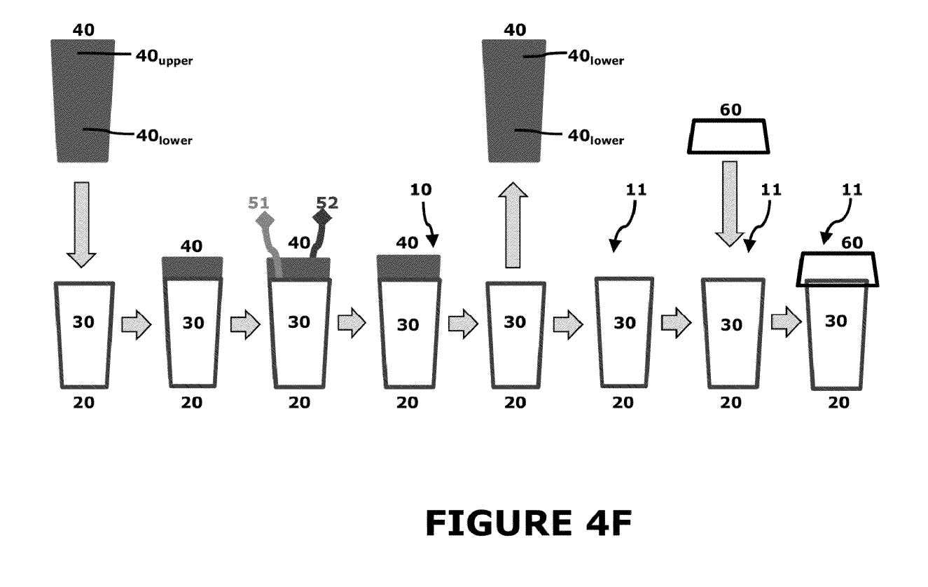

As shown in FIGS. 3E-3F, the separator-removing step is performed after the filling steps. If the separator 40 includes an upper portion 40ᵤₚₚₑᵣ extending above the cup's top rim 20ᵣᵢₘ, this portion can be grasped to allow removal without finger contact with the semi-frozen slurries 51-52. That being said, semi-frozen slurries 51-52 having mounds projecting beyond the cup's top rim 20ᵣᵢₘ is feasible and foreseeable. As shown in FIGS. 4A-4F, a lid 60 can be placed on the cup 20 after the separator-removing step. In either or any case, the separator 40 can be discarded after the removing step, or it can be reused to make another beverage 10, 11.

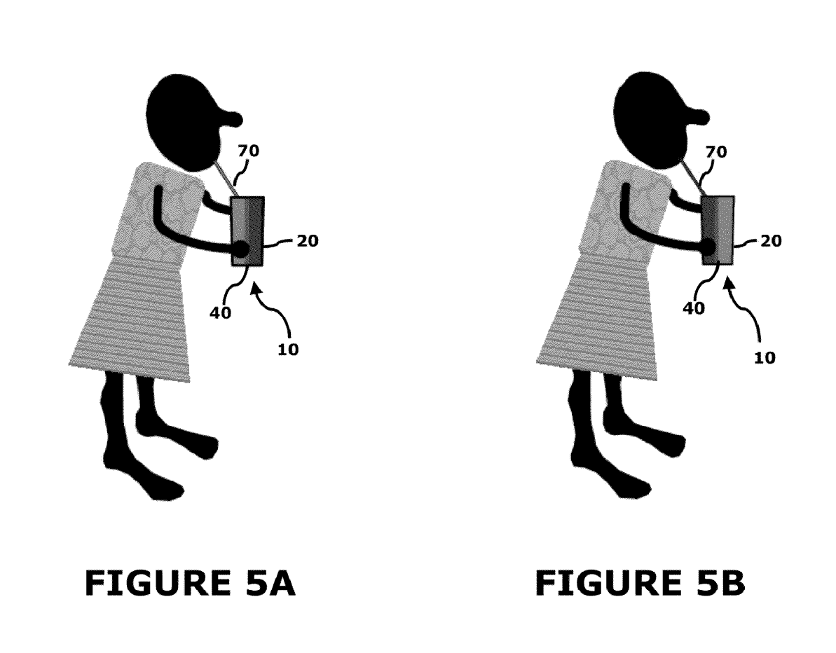

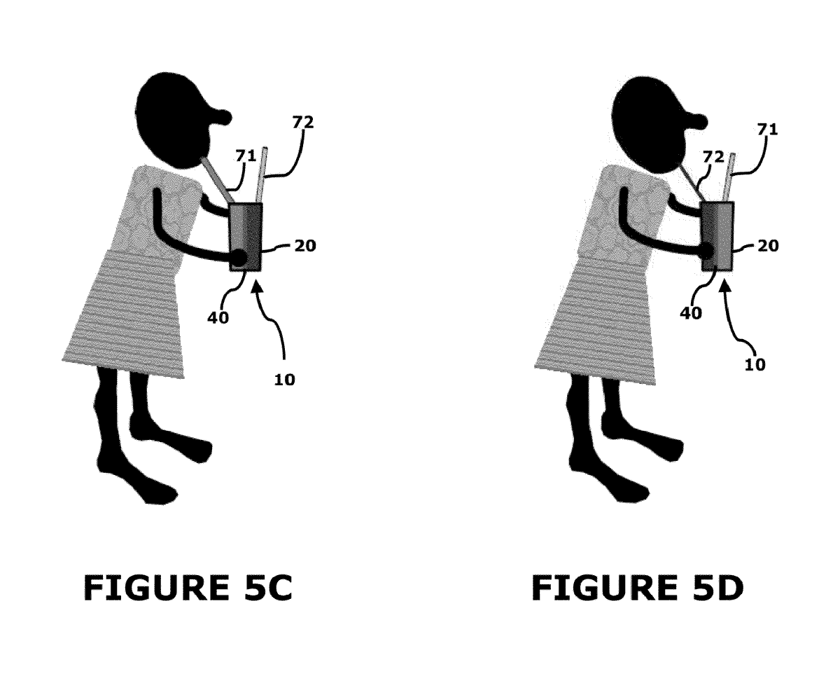

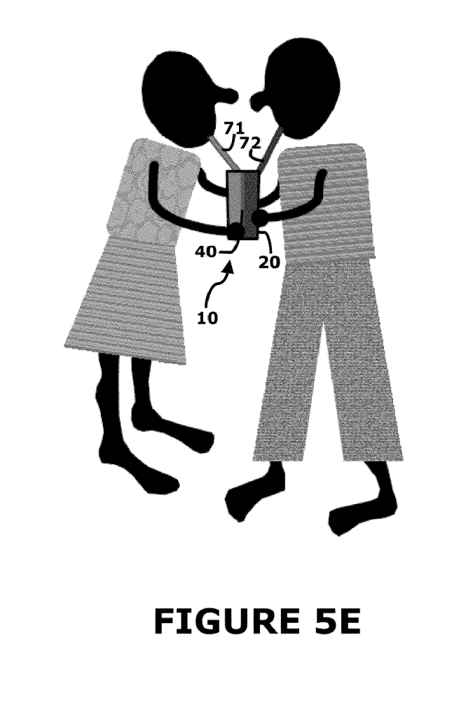

As shown in FIGS. 5A-5E, with a person can enjoy a lid-less beverage 10 (with the separator 40 still within the cup 20) with a single straw 70. The single straw 70 can be placed in one compartment 31 to withdraw the semi-frozen slurry 51 and then moved to the other compartment 32 to withdraw the semi-frozen slurry 52 (FIGS. 5A-5B). Alternatively, a person can enjoy the beverage 10 by having separate straws 71-72 for each compartment 31-32 (FIGS. 5C-5D). And two people can enjoy the beverage 10 at the same time with separate straws 71-72 for each compartment 31-32 (FIG. 5E).

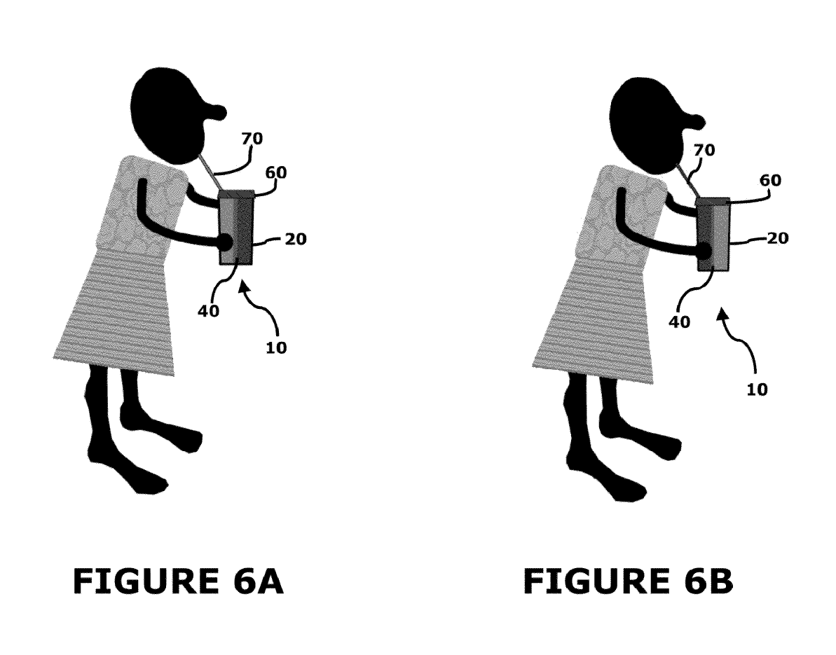

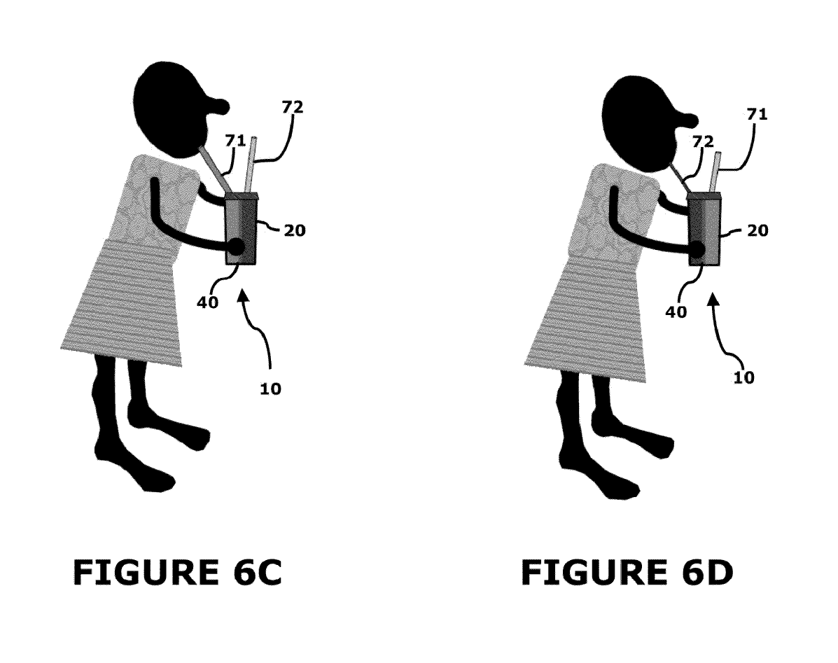

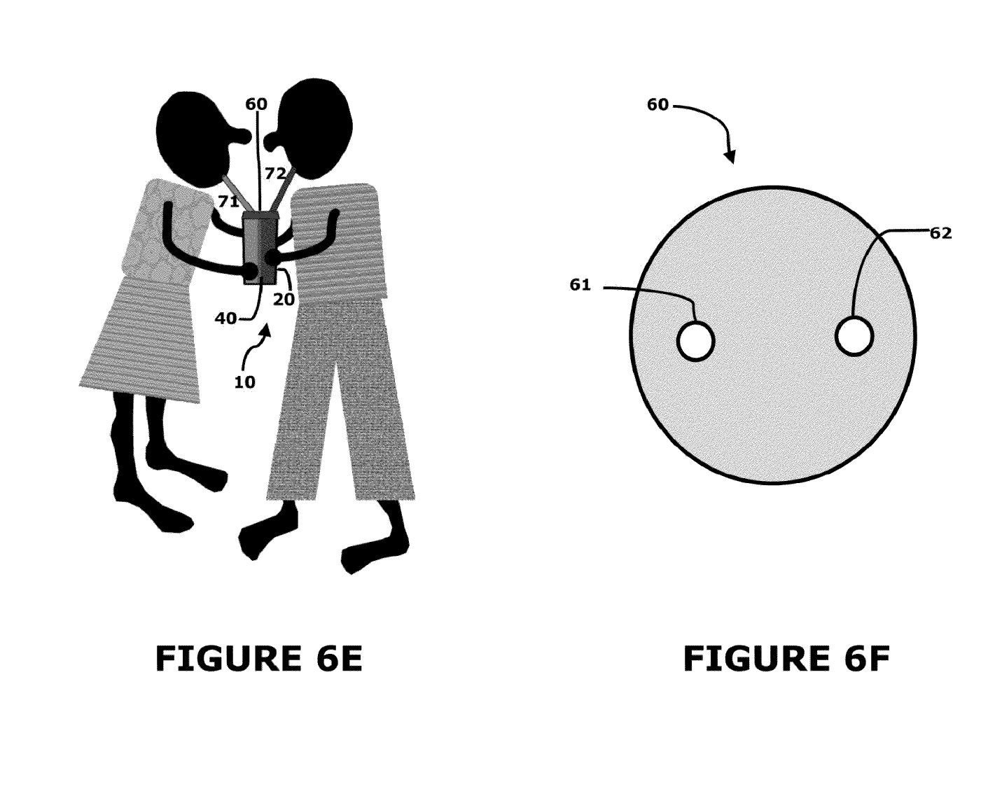

As shown in FIGS. 6A-6F, a person can enjoy a lidded beverage 10 (with the separator 40 in the cup 20) in similar manner with a single straw 70 or with a straw 71-72 for each compartment 31-32 (FIGS. 6A-6D). And two people can enjoy the lidded beverage 10 at the same time (FIG. 6E). With this arrangement, the lid 60 could have two holes 61-62 alignable with the compartments 31-32 (FIG. 6F).

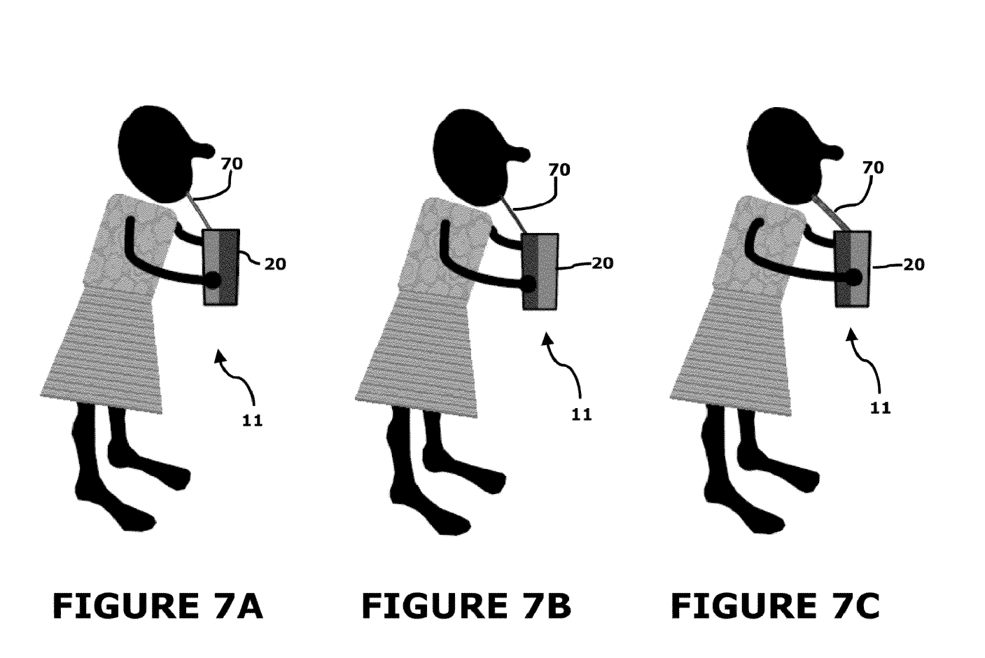

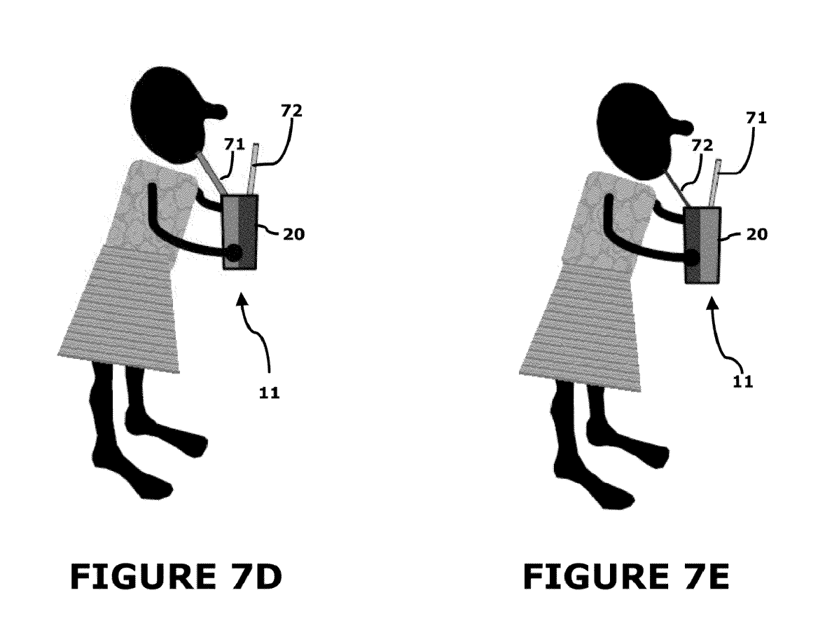

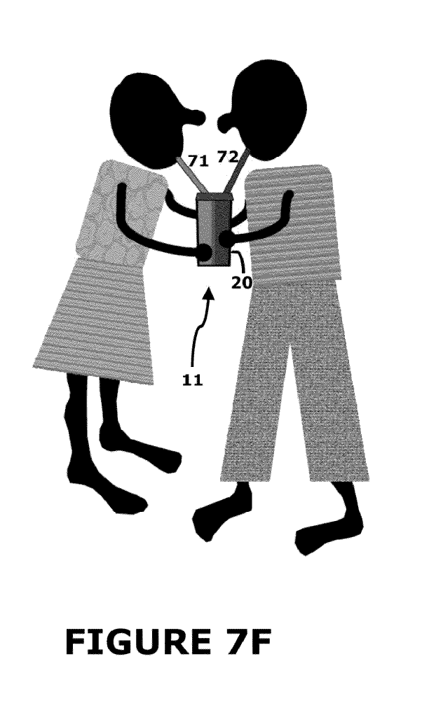

As shown in FIGS. 7A-7F, a person can enjoy a beverage 11 (with the separator 40 removed from the cup) with a single straw 70 moved between the compartments 31-32 (FIGS. 7A-7B). A person can also enjoy the beverage 11 with a single straw 70 situated to simultaneously withdraw the slurries 51-52 from both of the compartments 31-32 (FIG. 7C). Alternatively, the beverage 11 can be enjoyed with two straws 71-72 for the compartments 31-32 either by a solely or jointly (FIGS. 7D-7E, and FIG. 7F).

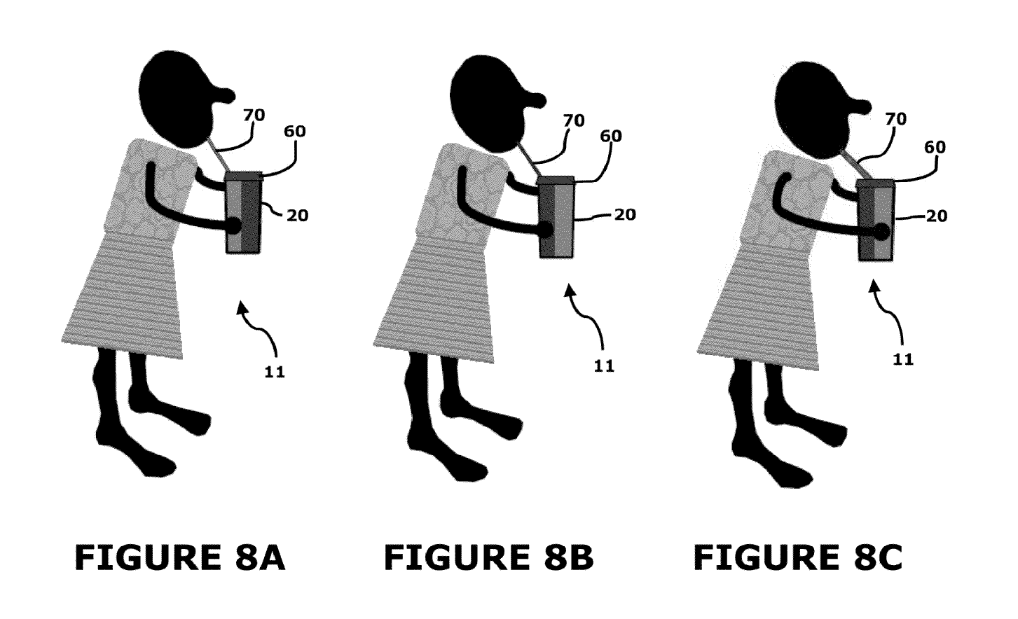

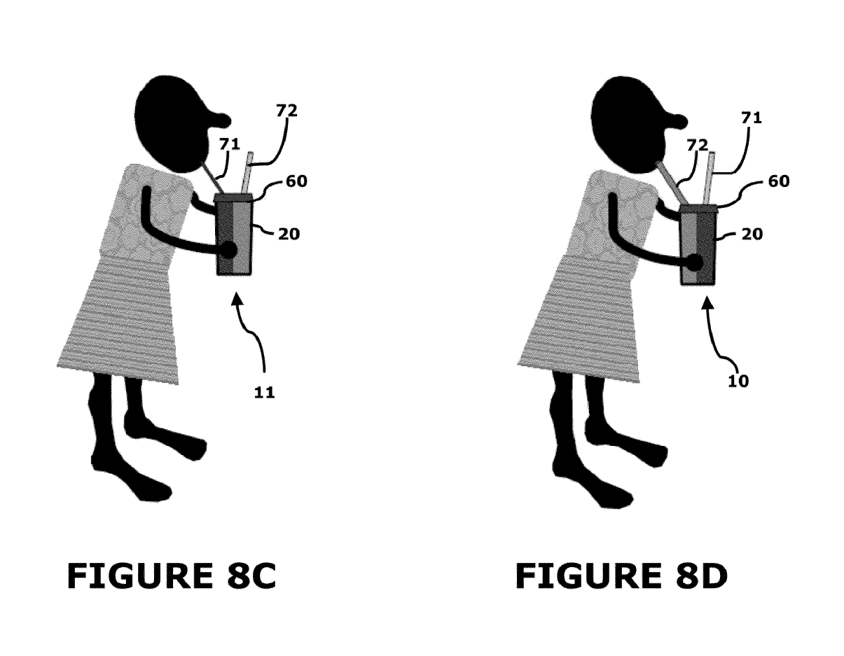

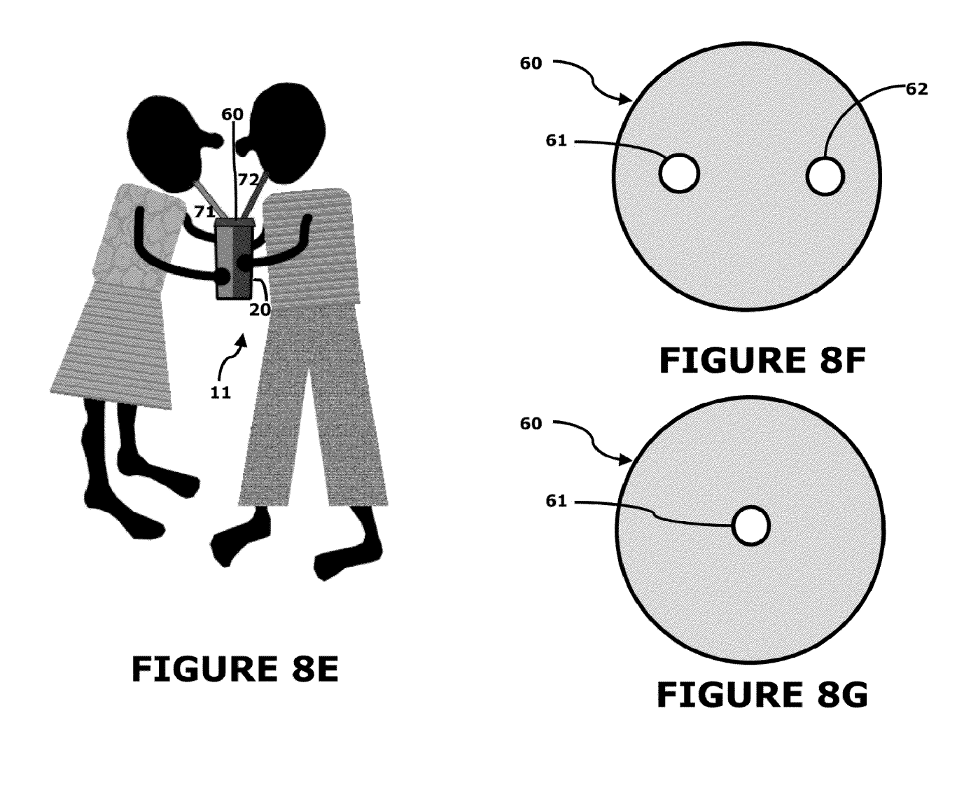

As shown in FIGS. 8A-8H, a lidded beverage 11 can be enjoyed in a similar manner as the non-lidded beverage shown in FIGS. 7A-7F. With the single-straw enjoyment shown in FIGS. 8A-8B and the straw-per-compartment enjoyment shown in FIG. 8D-8F, the lid 60 could have two holes 61-62 alignable with the compartments 31-32 (FIG. 8G). With the single-straw drinking arrangement shown in FIG. 8C, the lid 60 could have only one hole 61 (FIG. 8H).

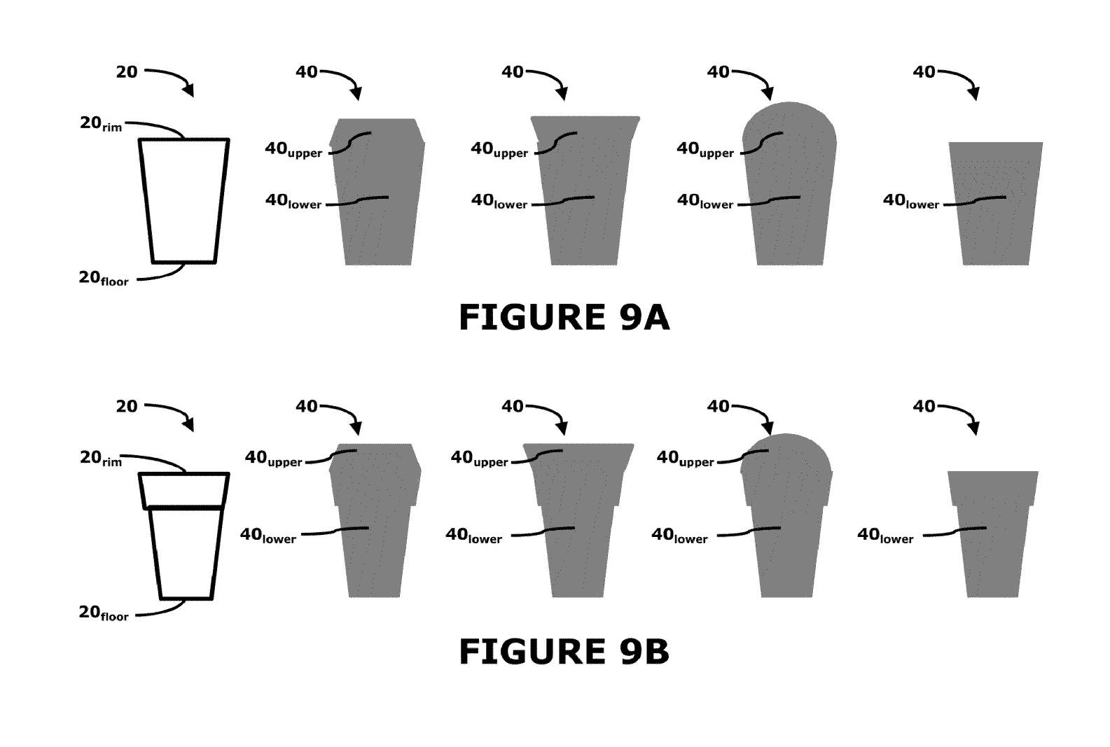

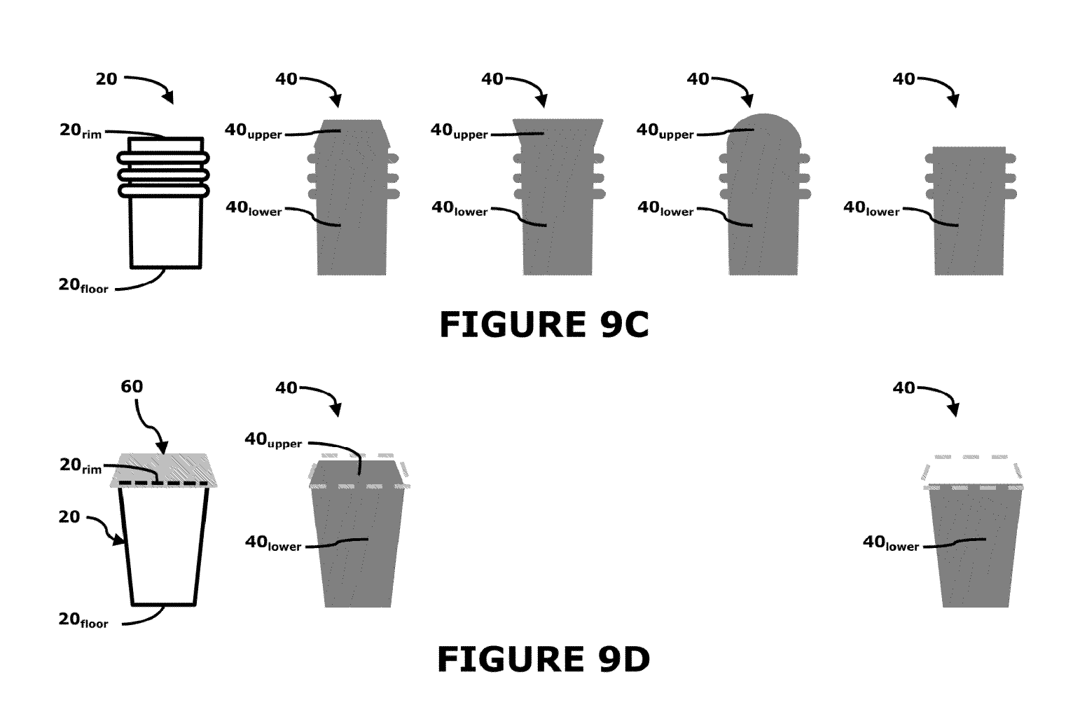

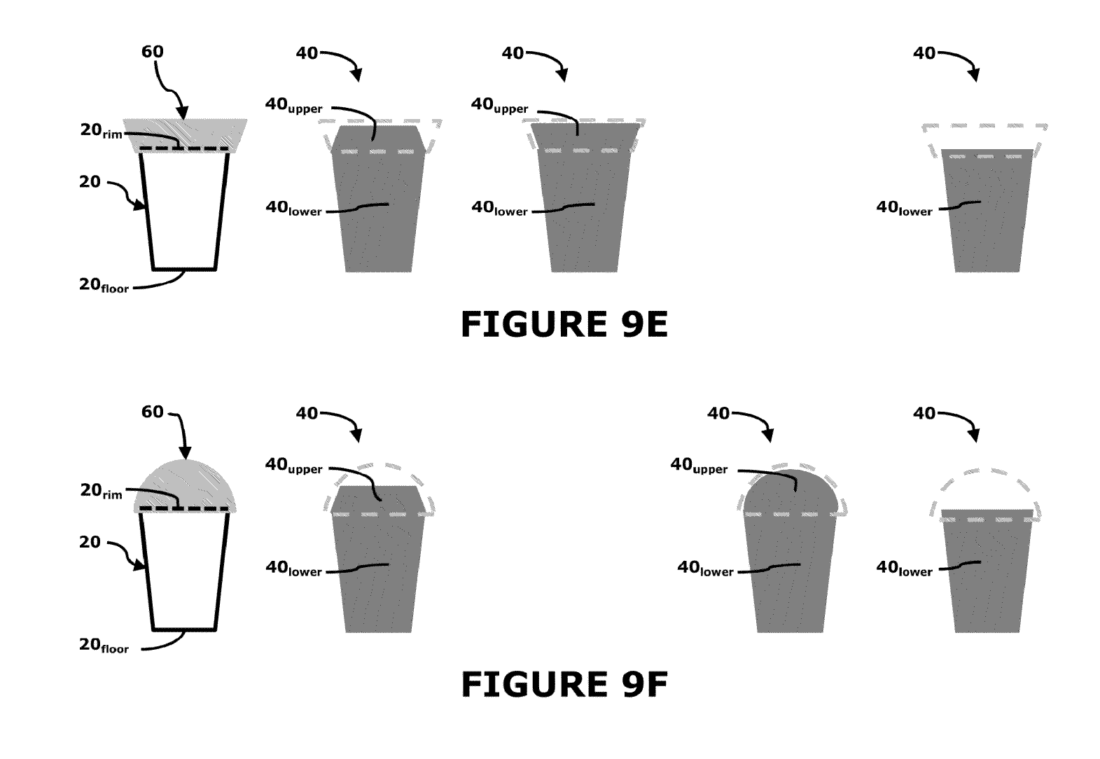

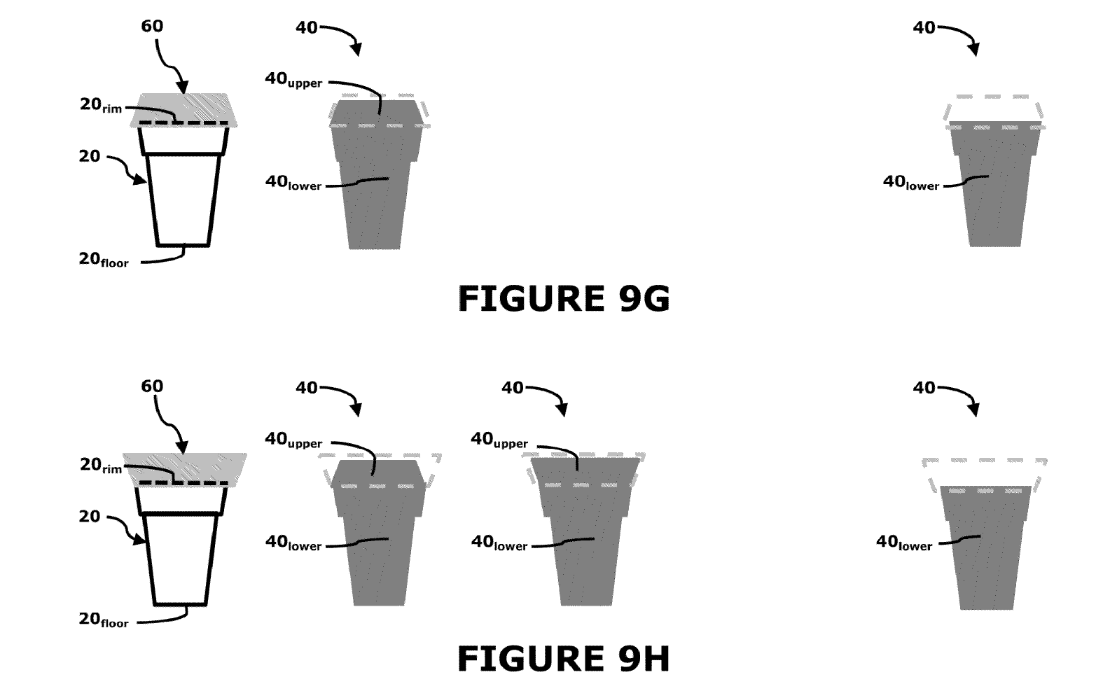

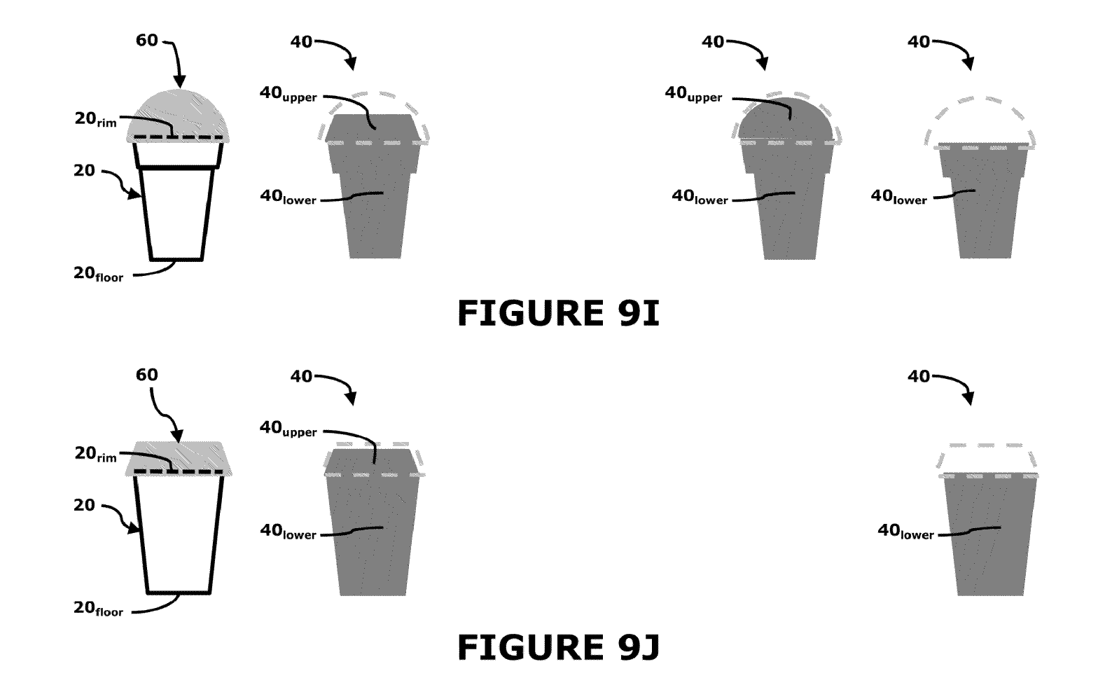

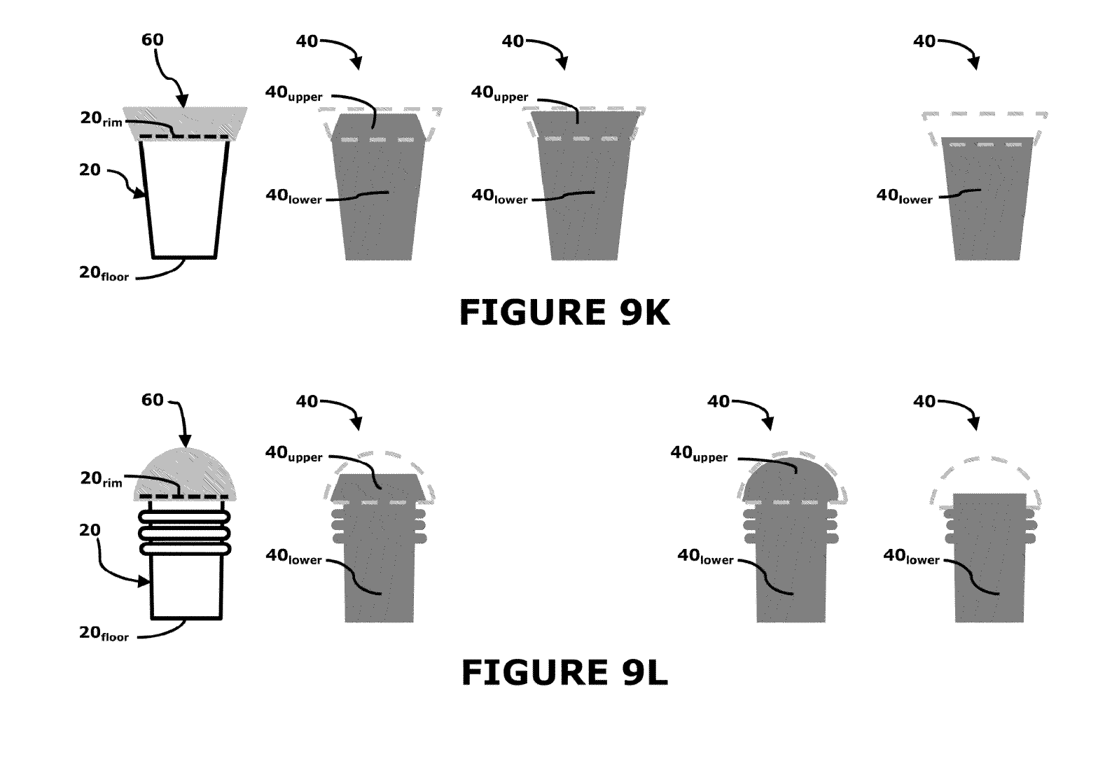

As shown in FIGS. 9A-9L, the separator 40 can have a variety of profiles depending upon the cup 20 and/or the lid 60 being used. The separator's lower portion 40_{lower} can be, for example, tapered upwardly, stepped, and/or ribbed. The separator's upper portion 40ᵤₚₚₑᵣ can be, for example, converging, diverging, domed, or non-existent. Both portions of the separator may have the same or different profiles. While it is contemplated that a separator 40 will be constructed to correspond to a conventional cup 20 and/or a standard lid 60, a cup 20 and/or a lid 60 specifically designed to adapt to a particular separator profile is possible and predicted.

It should be understood that while the separators shown are withdrawn from the cup by a vertical movement, the separator can be removed with a movement that combines rotation and vertical movement. The separator and cup could also form a thread-like connection requiring rotational and vertical movement to separate the two components. The separator and cup may also include locking features that allow the two to only be separated after a twist of the components or by following a particular pattern of movements. Movements of the separator during removal may create a pattern in the different color slurries in the compartments created by the separator. These patterns may be visible if the cup used is a clear cup, and could be designed to be decorative.

With particular reference to the lidded beverage 10 shown in the 2nd series of drawings, a common practice is to add additional slurry after the lid 60 is placed on the cup 20. This “topping off” is especially popular when the beverage 10 is a slushie. And/or it is especially popular with the lid 60 has a domed profile whereby a topped-off beverage can hold a significant amount of slurry above the container space 30.

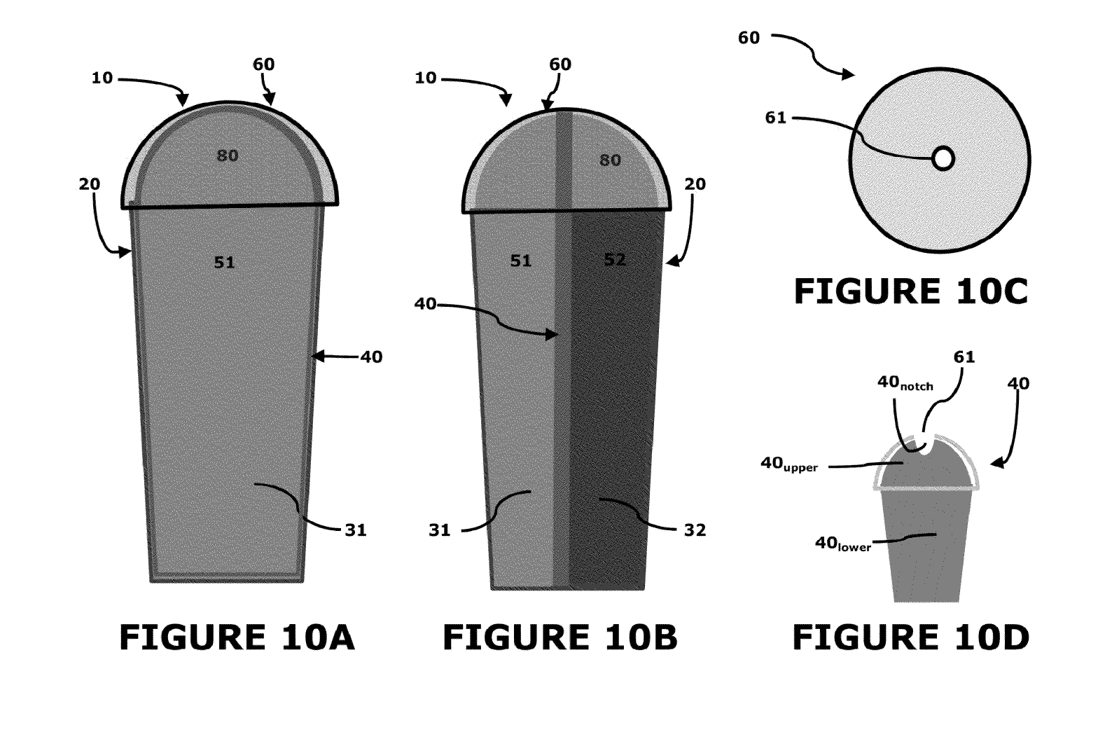

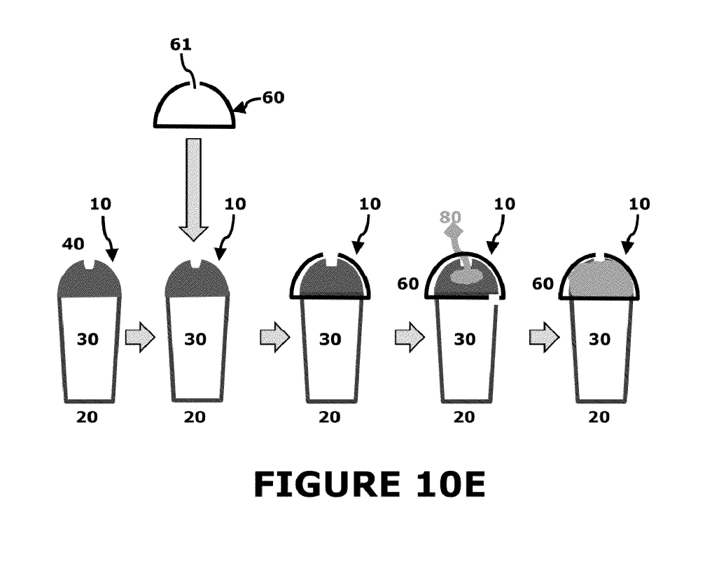

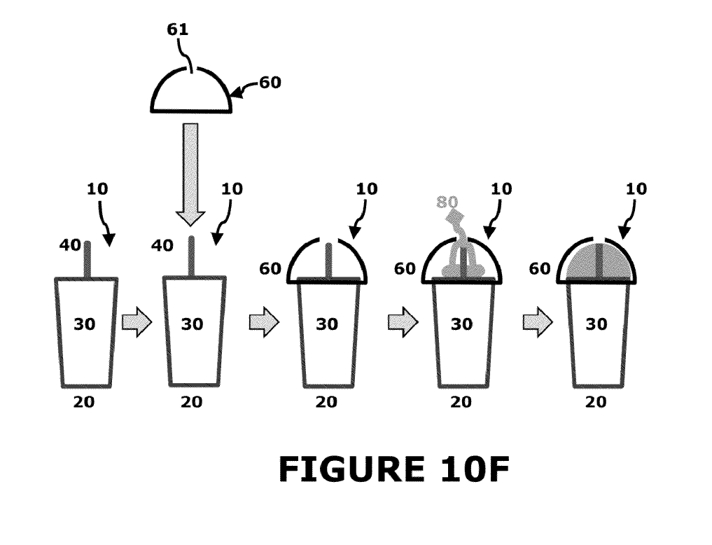

As shown in FIGS. 10A-10F, a tall separator 40 can be adapted to accommodate a topping-off step when the lid 60 has a single straw hole 61. Specifically, the separator 40 can be provided with notch 40_{notch} on its top edge which aligns with the lid's straw hole 61. The notch 40_{notch} insures that the separator 40 does not impeded slurry flow through the straw hole 61 when making the beverage 10.

The slurry 80 can be the same color/flavor as the slurry 51, or the slurry 80 can be the same color/flavor as the slurry 52, or the slurry 80 can be a different color/flavor than both slurries 51-52. It might also be possible to provide different colored slurries 80 in horizontal layers in the lid space. But vertically aligning slurries in the lid 60 with those in the container space 30 would probably prove difficult.

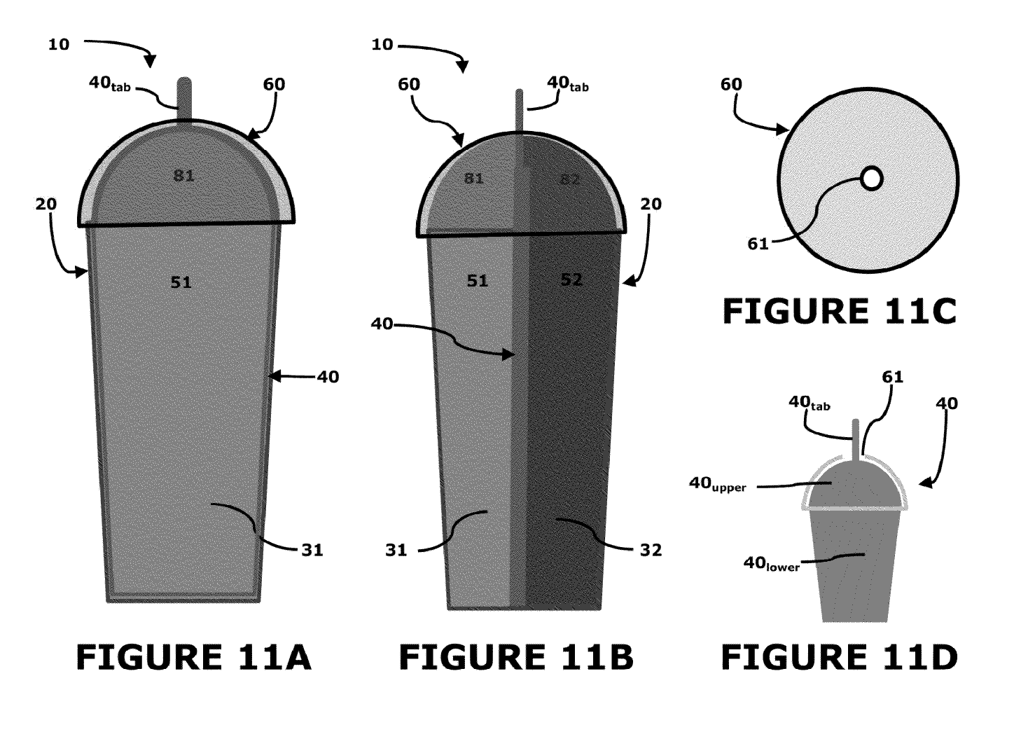

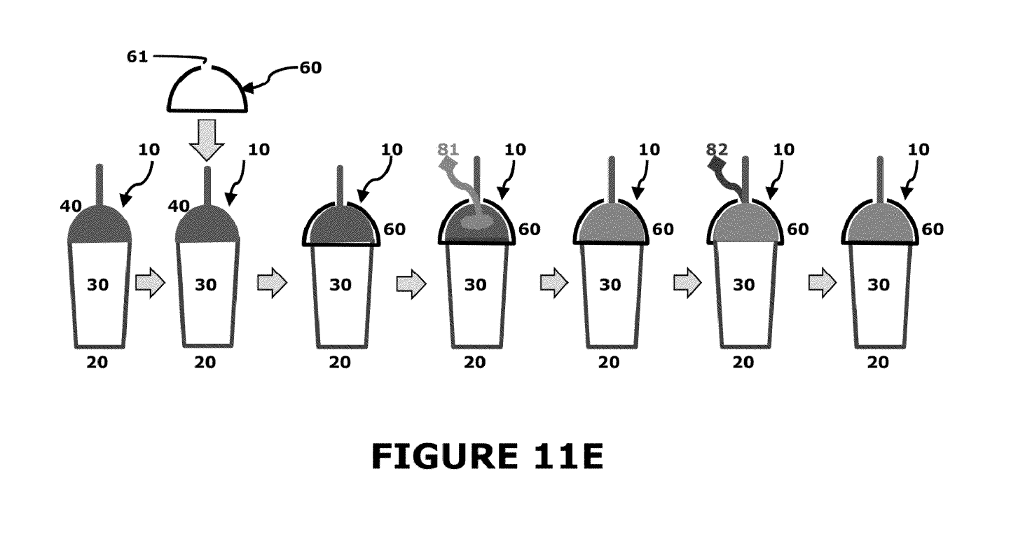

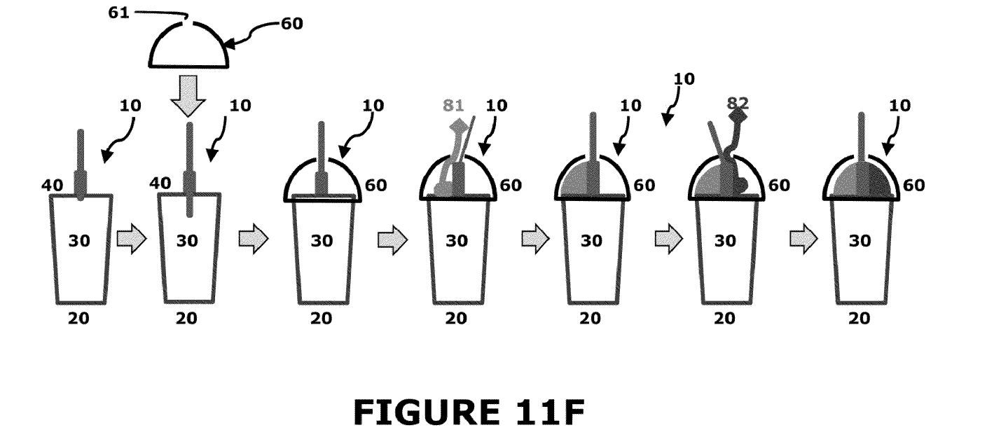

As shown in FIGS. 11A-11F, a notch-less separator 40 may also be used to accommodate a topping-off step when the lid 60 has a single straw hole 61. With this separator 40, a tab 40_{tab} extends upward from its top edge and through the straw hole 61 in the lid 60. The tab 40_{tab} is adapted so as to be movable from one side of the straw hole 61 to the other while still allowing ample area for the introduction of slurries 81-82.

The slurry 81 can be the same color/flavor as the slurry 51 (as shown), or the slurry 81 can be the same color/flavor as the slurry 52, or the slurry 81 can be a different color/flavor than both slurries 51-52. Likewise, the slurry 82 can be the same color/flavor as the slurry 51, or the slurry 82 can be the same color/flavor as the slurry 52 (as shown), or the slurry 81 can be a different color/flavor than both slurries 51-52. Additionally or alternatively, the slurries 81-82 can also be the same color/flavor. It might also be possible to provide different colored slurries 81-82 in horizontal layers in the lid space.

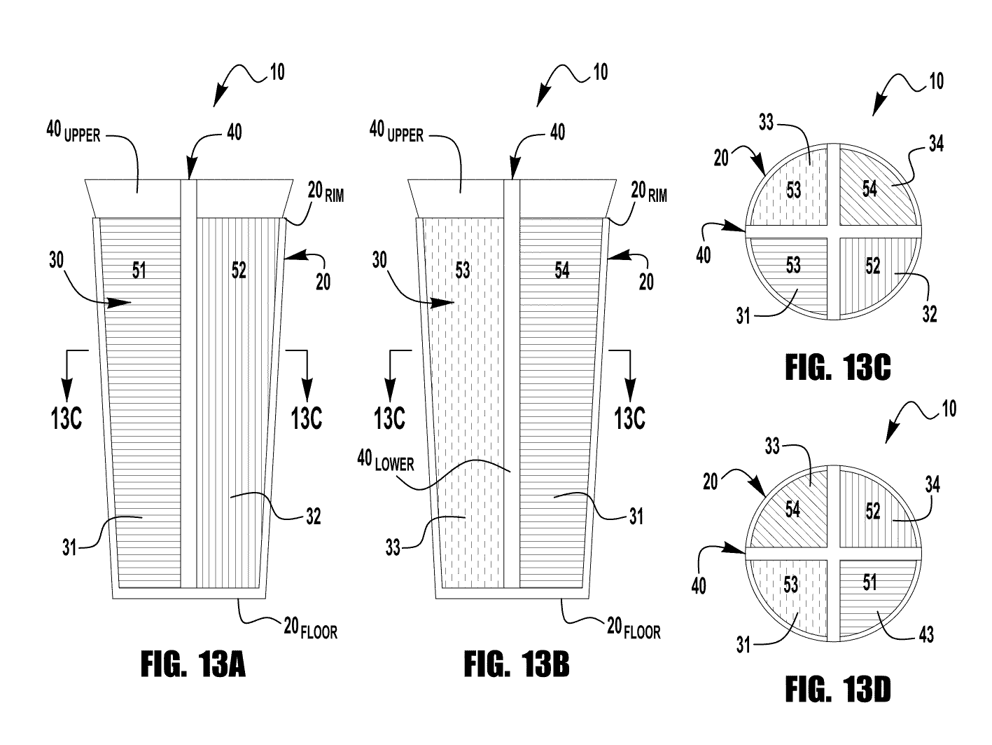

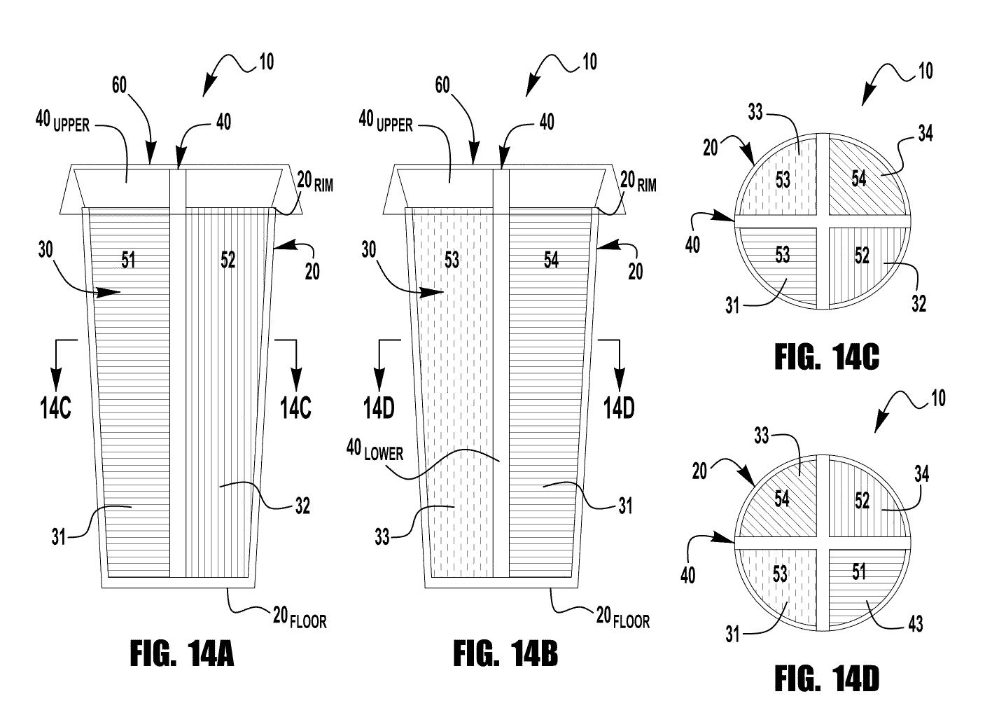

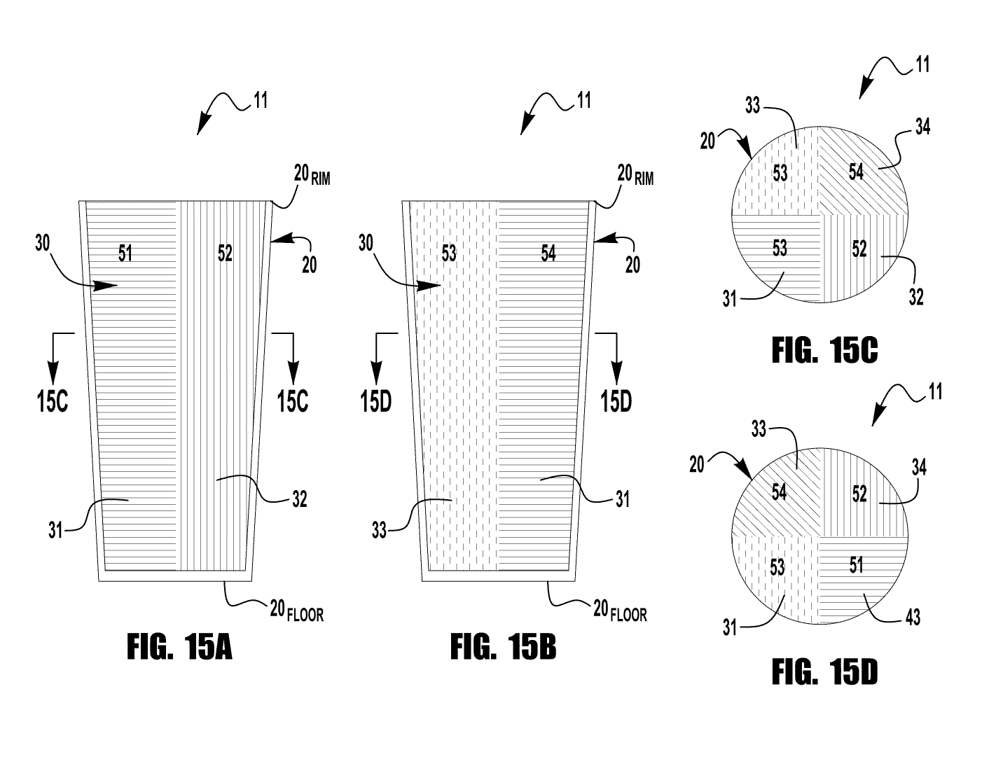

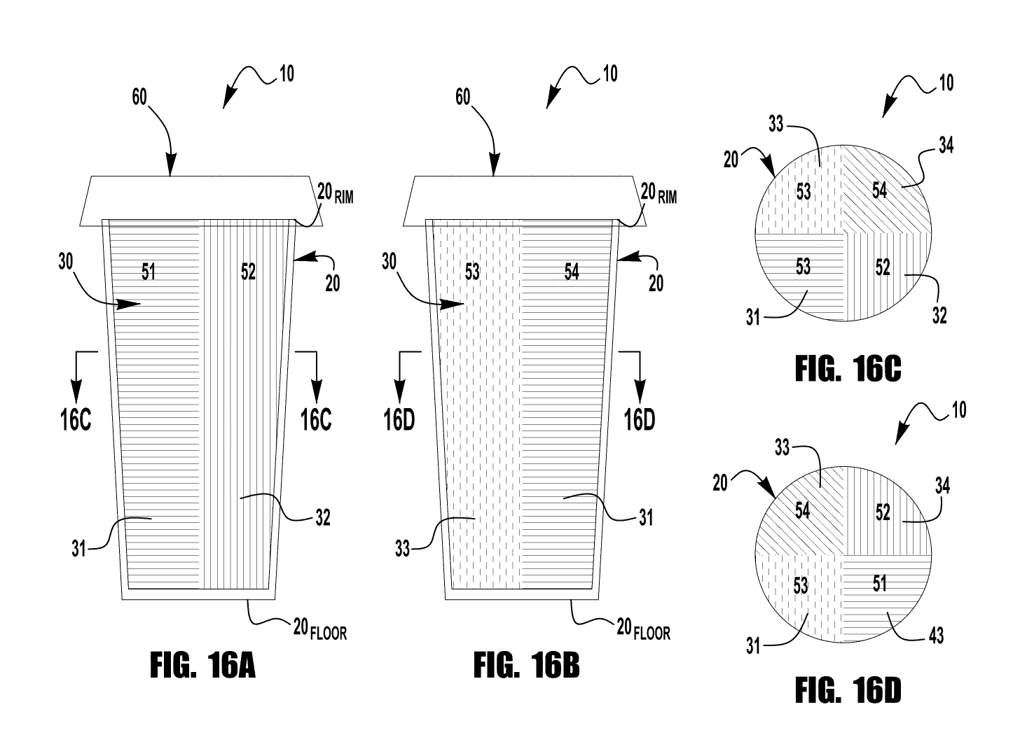

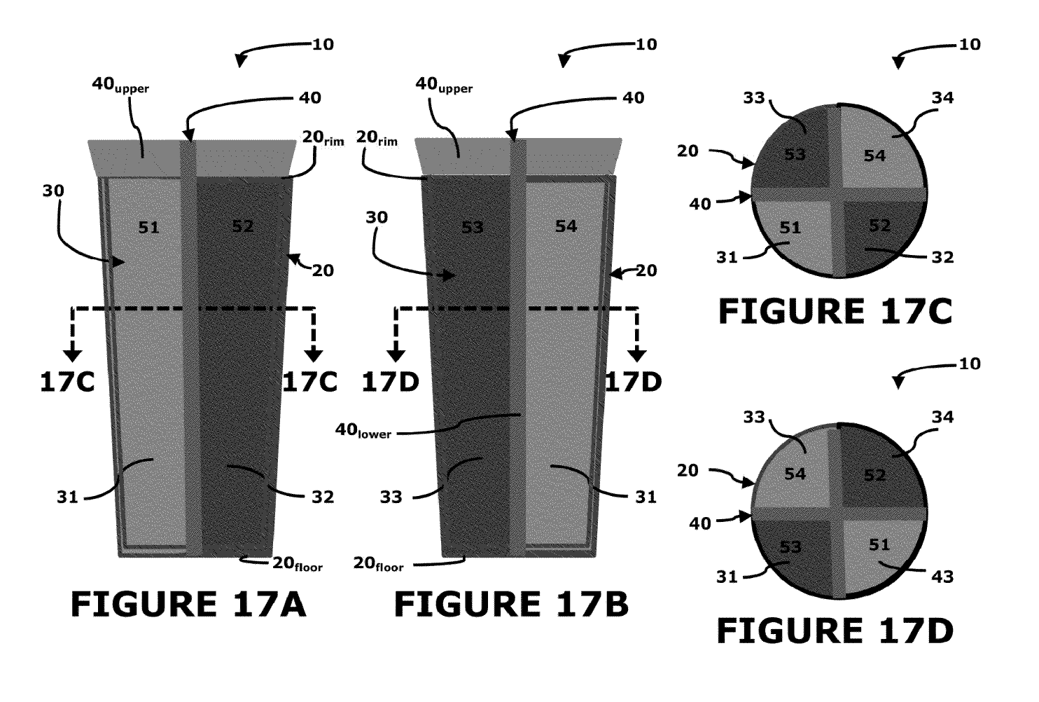

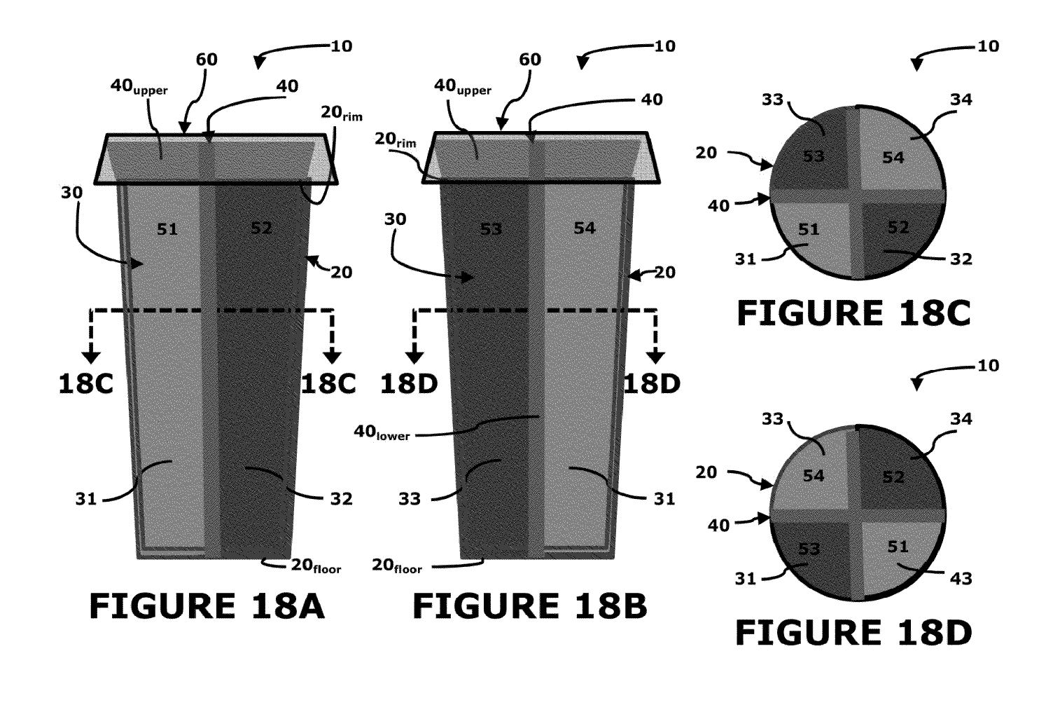

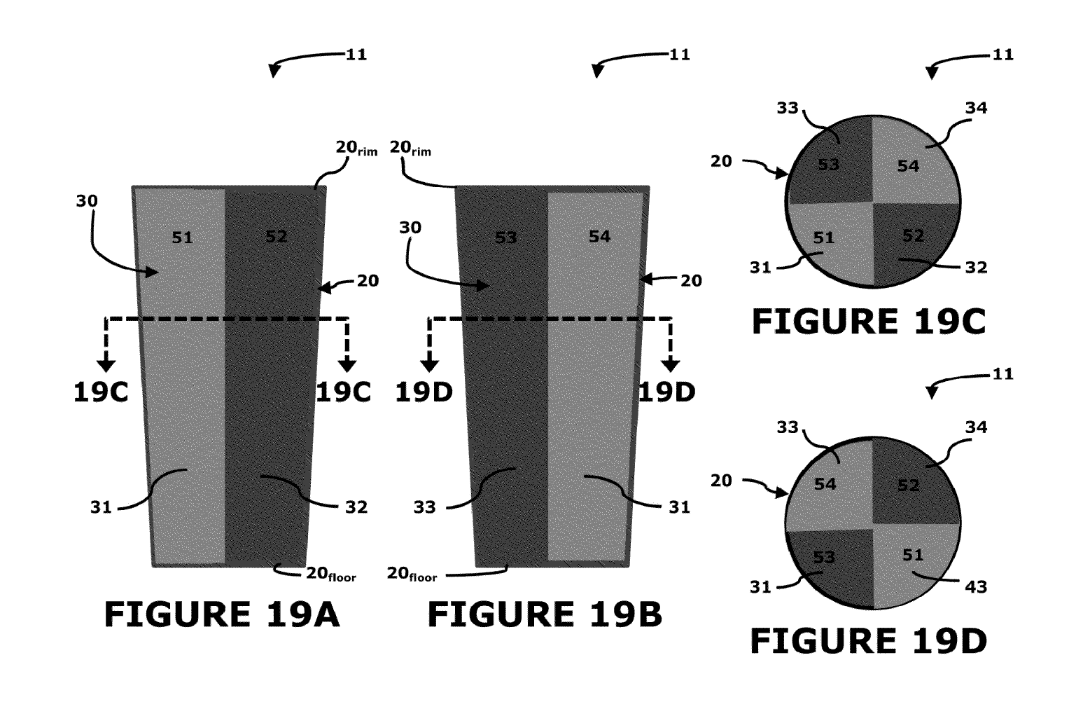

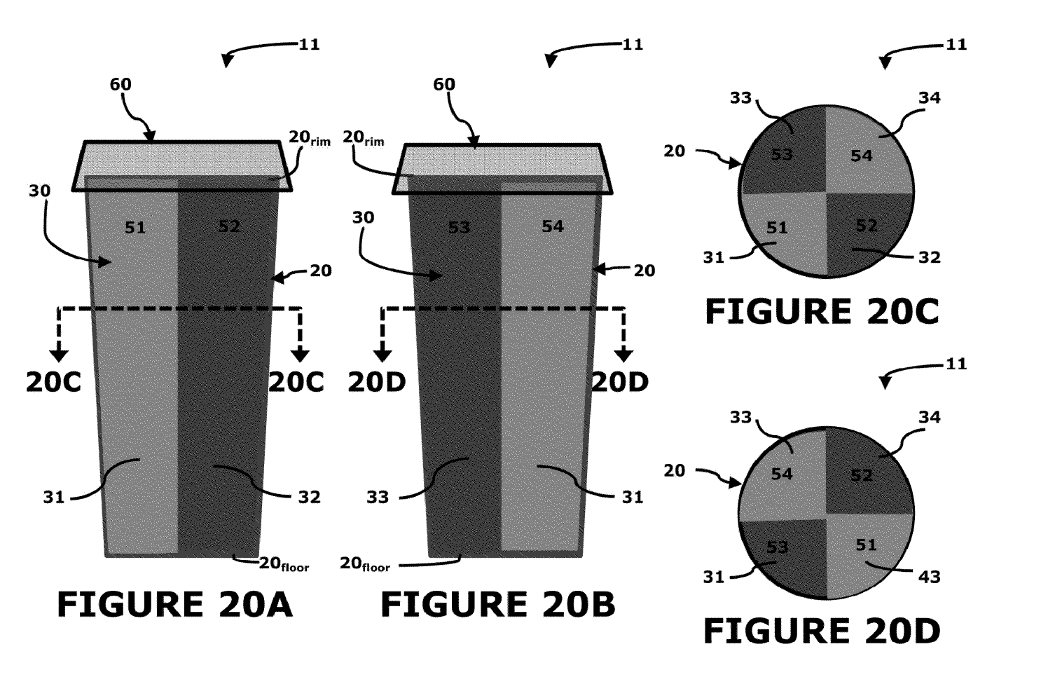

Referring to the 13th through 20th series of drawings, a multi-color slurry beverage 10, 11 is shown having four compartments 31-34 filled respectively with semi-frozen slurries 51-54. The separator 40 has a cross-like shape dividing the container space 30 into four quarter-cylinder compartments. In FIGS. 13A-13D, FIGS. 14A-14D, FIGS. 15A-15D, and FIGS. 16A-16D, the separator 40 the semi-frozen slurries 51-54 are of four different colors. In FIGS. 17A-17D, FIGS. 18A-18D, FIGS. 19A-19D, and FIGS. 20A-20D, the frozen beverages 51 and 53 are a first color and the frozen beverages 52 and 54 are a second color that is different from the first color.

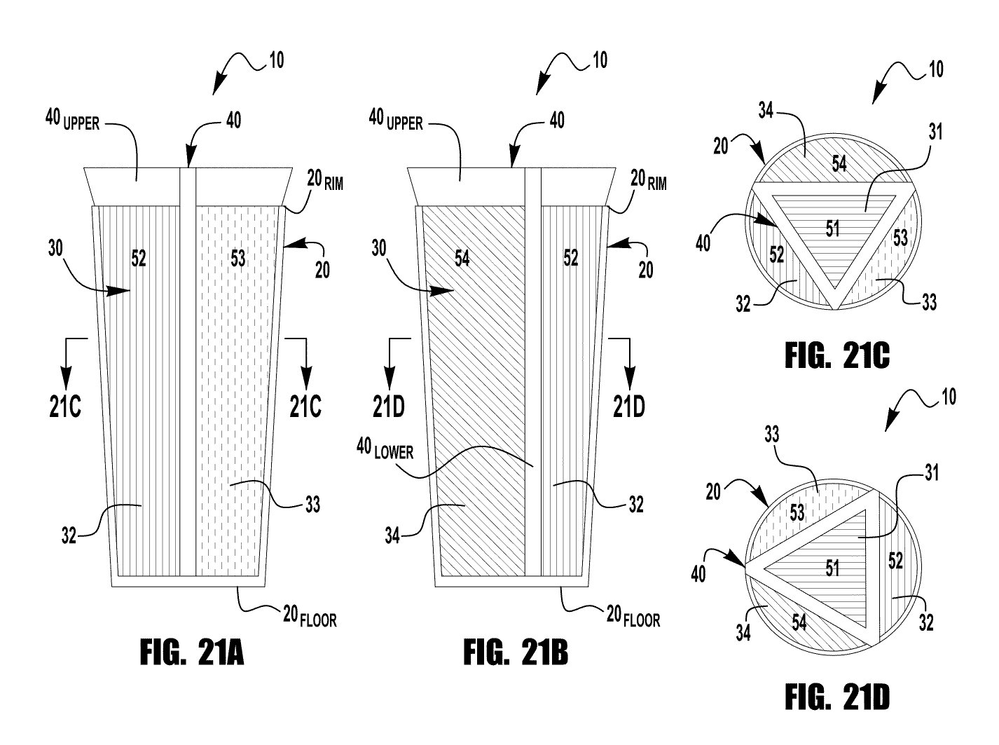

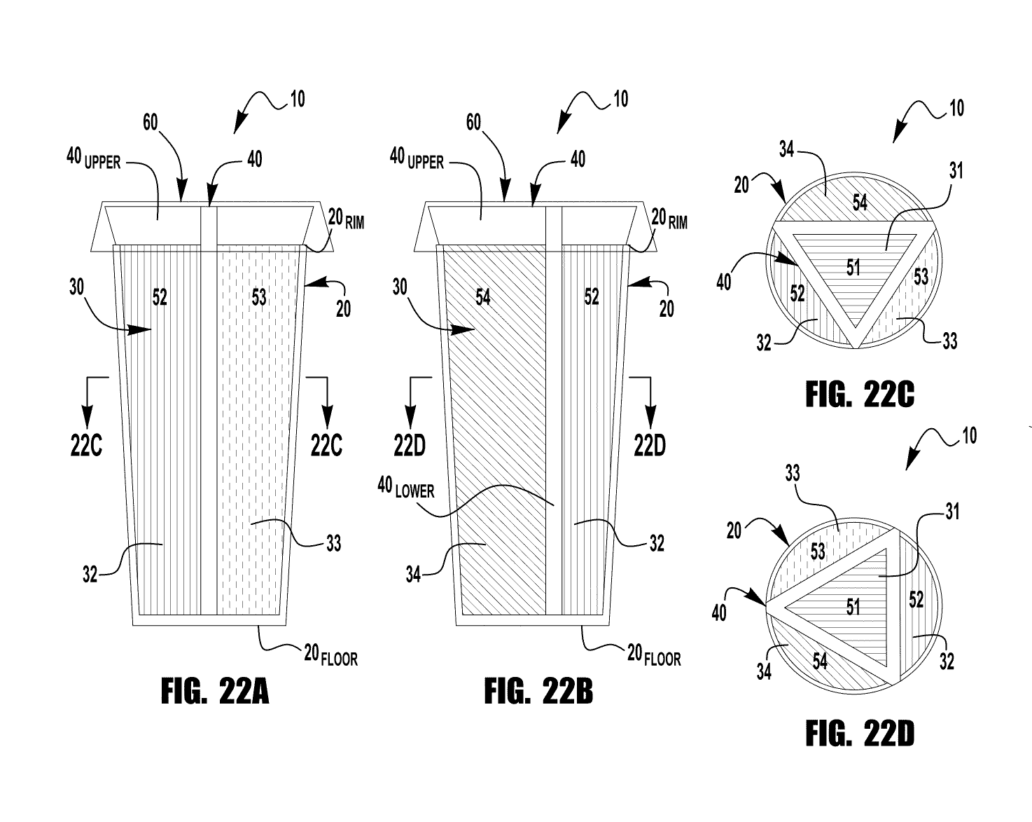

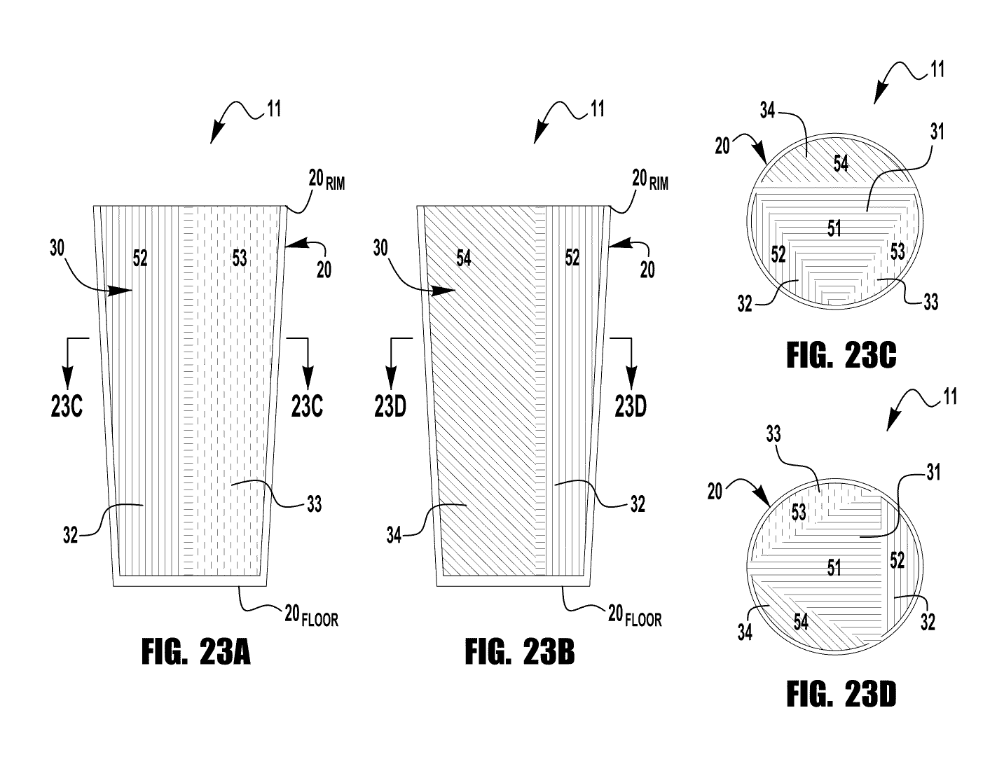

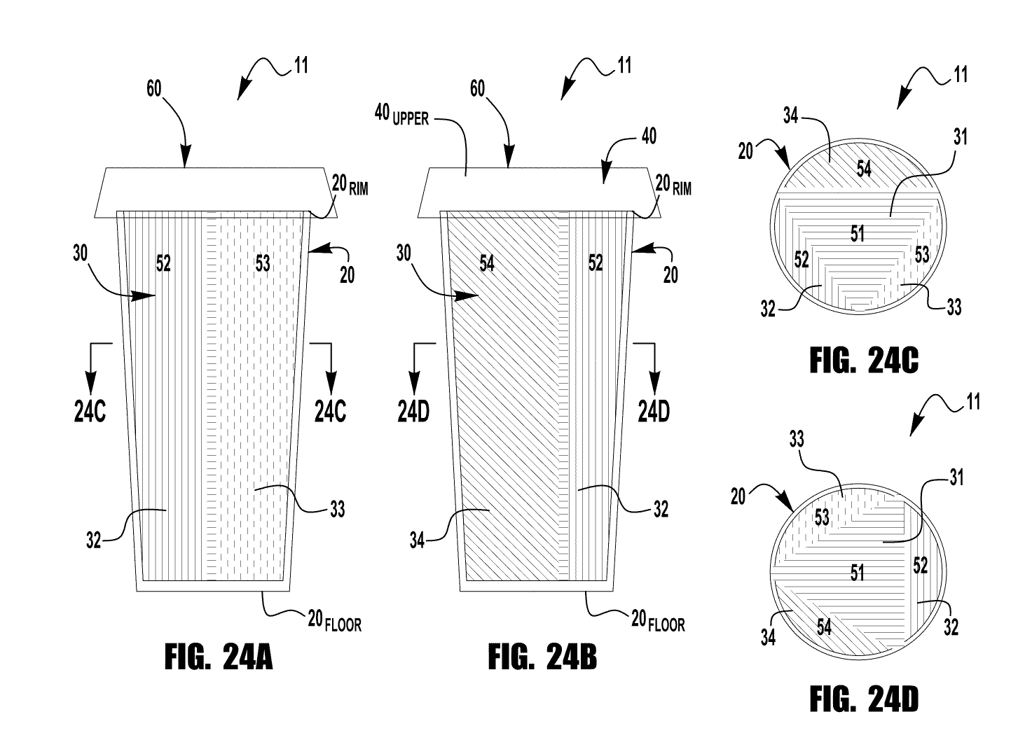

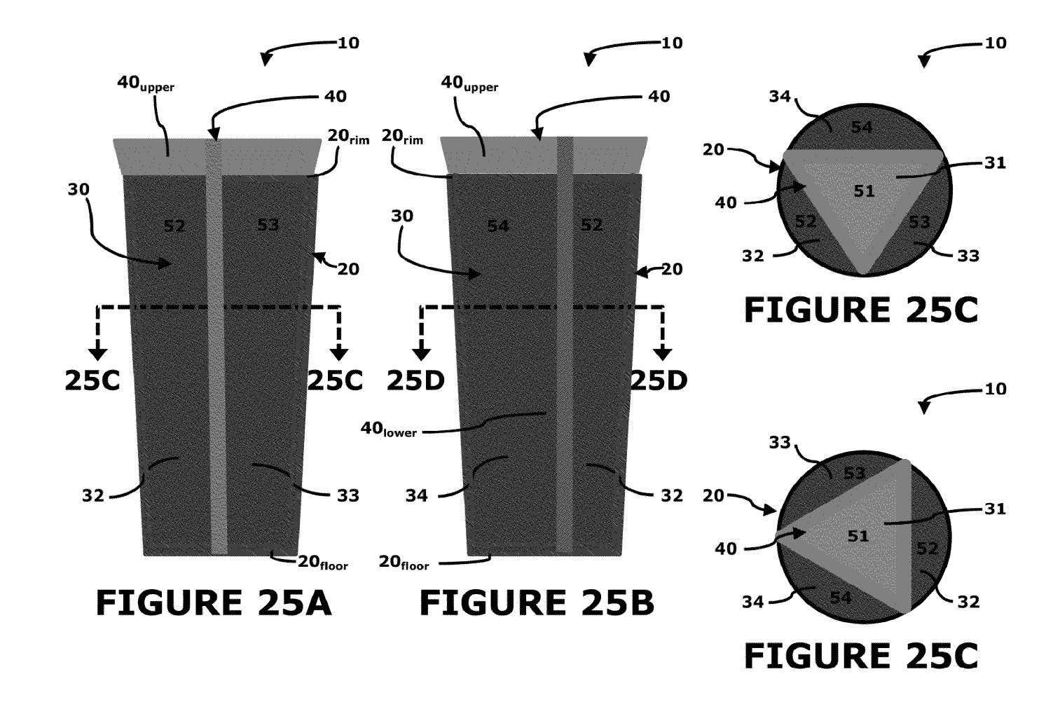

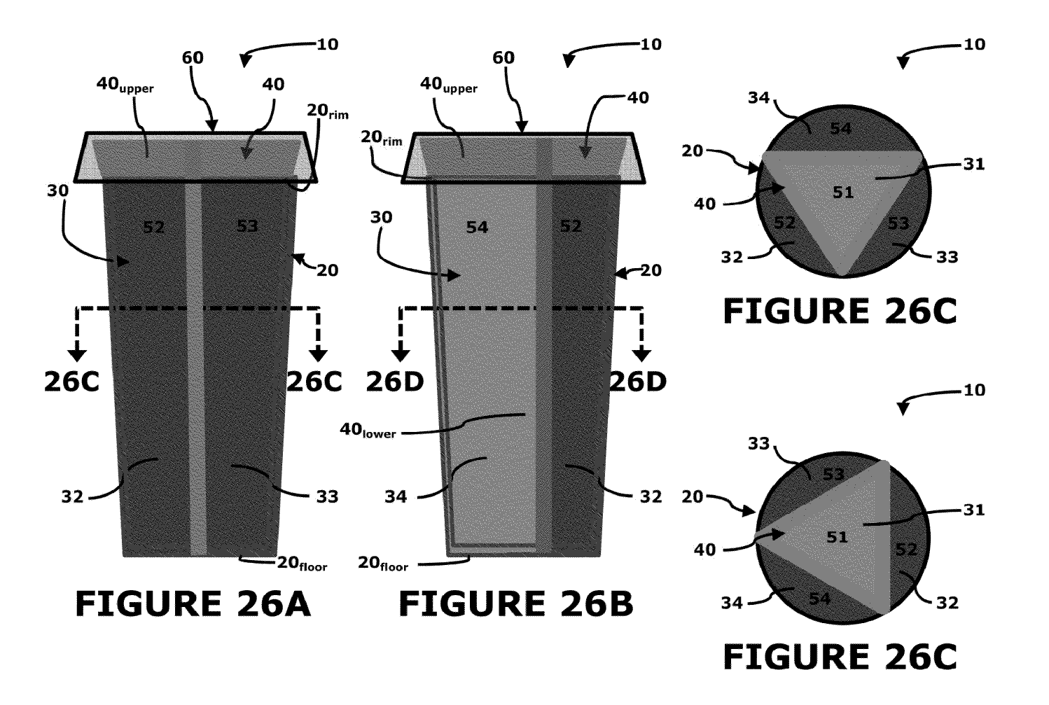

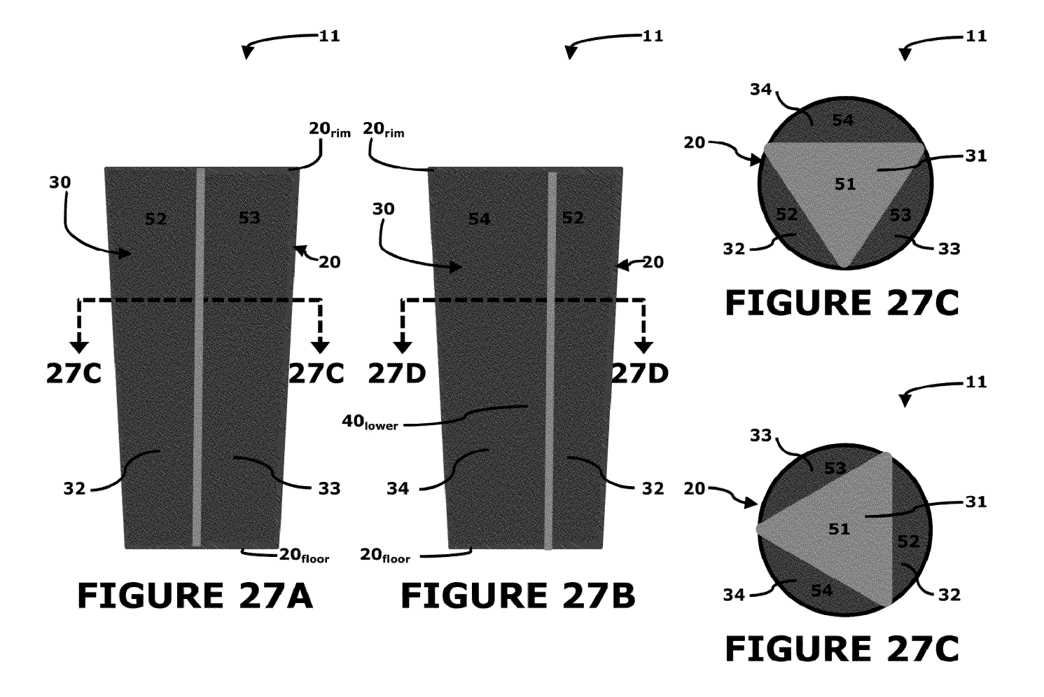

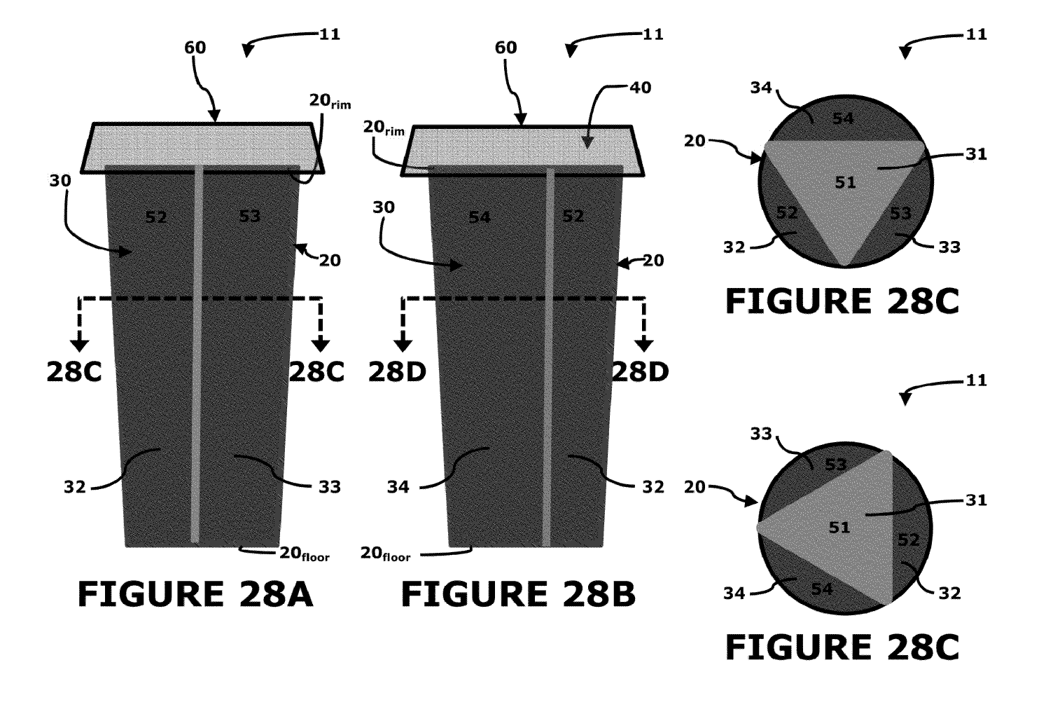

Referring to the 18th through 25th series of drawings, another multi-color slurry beverage 10, 11 is shown having four compartments 31-34 filled respectively with semi-frozen slurries 51-54. The separator 40 has a prism-like shape dividing the container space 30 into central triangular compartment 51 with arc-shaped compartments 52-54 therearound. In FIGS. 21A-21D, FIGS. 22A-22D, FIGS. 23A-23D, and FIGS. 24A-24D, the semi-frozen slurries 51-54 are of four different colors. In FIGS. 25A-25D, FIGS. 26A-26D, FIGS. 27A-27D, and FIGS. 28A-28D, the central compartment 51 is a first color and the outer compartments 52-54 are a second color.

The four-compartment beverages 10, 11 can be made in much the same manner as the two-compartment beverages 10, 11 discussed above, with each of the four compartments 31-34 being filled with semi-frozen slurries 51-54. The four-compartment beverages 10, 11 can also be enjoyed in a similar way either with a single straw or a plurality of straws. And as with two-compartment beverages, they can be lidded and further semi-frozen slurry introduced to the lidded space above the container space.

Although the beverage 10, the beverage 11, the cup 20, the container space 30, the separator 40, the semi-frozen slurries 51-54, the lid 60, and/or the straws 70 have been shown and described with respect to a certain embodiments, it is obvious that equivalent alterations and modifications will occur to others skilled in the art upon the reading and understanding of this specification and the annexed drawings.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and illustrative examples shown and described. Accordingly, departures may be made from such details without departing from the spirit or scope of the applicants' general inventive concept.

What is claimed is:

1. A multi-color slurry beverage comprising:
a cup having a floor and a top rim,
a container space defined by the cup,
a separator within the container space separating it into a first compartment and a second compartment,
a first semi-frozen slurry filling the first compartment, and
a second semi-frozen slurry filling the second compartment;
wherein the first compartment and the second compartment each extend from the cup's floor to a top rim of the cup, and
wherein the separator is selectively removable from the cup by manually pulling it out of the container space.

2. A multi-color slurry beverage as set forth in claim 1, wherein the separator comprises a rigid sheet-like structure having a first side defining an inner wall of the first compartment and a second side defining an inner wall of the second compartment.

3. A multi-color slurry beverage as set forth in claim 1, wherein the first semi-frozen slurry has a first color, wherein the second semi-frozen slurry has a second color, and wherein the first color and the second color are visually distinguishable from each other.

4. A multi-color slurry beverage as set forth in claim 1, wherein the separator extends above the top rim of the cup.

5. A multi-color slurry beverage as set forth in claim 4, further comprising a lid which fits over the separator and creates lid space above the container space.

6. A multi-color slurry beverage as set forth in claim 5, wherein the lid includes a single straw hole, and wherein the separator includes a notch along its top edge aligned with this straw hole.

7. A multi-color slurry beverage as set forth in claim 5, wherein the lid includes a single straw hole, and wherein the separator includes a tab extending upward from its top edge through this straw hole.

8. A multi-color slurry beverage as set forth in claim 5, wherein the lid has a straw-receiving hole aligned with each compartment.

9. A multi-color slurry beverage as set forth in claim wherein the first color and the second color are each selected from a group consisting of pink, red, orange, yellow, green, blue, purple, brown, grey, white, and mixtures thereof.

10. A multi-color slurry beverage as set forth in claim 1, wherein the first semi-frozen slurry is a first flavor and wherein the second semi-frozen slurry is a second flavor.

11. A multi-color slurry beverage as set forth in claim 10, wherein ingredients of the first slurry comprise ice particles, sweeteners, food coloring corresponding to the first color, and flavoring; and wherein the ingredients of the second slurry comprise ice particles, sweeteners, food coloring corresponding to the second color, and flavoring.

12. A method of making a multi-color slurry beverage, wherein the multi-color slurry beverage comprises a cup having a floor and a top rim, and a container space is defined by the cup, comprising the steps of:
inserting a separator in the container space, wherein the separator supports itself in an upright position and separates the container space it into a first compartment and a second compartment, wherein the first compartment and the second compartment each extend from the cup floor to the top rim of the cup, and wherein the separator is selectively removable from the cup by manually pulling it out of the container space,
filling the first compartment with a first semi-frozen slurry having a first color, and
filling the second compartment with a second semi-frozen slurry having a second color, wherein the first color and the second color are visually distinguishable from each other.

13. A method as set forth in claim 12, further comprising the steps of:
fitting a lid over the separator to form a lid space above the container space; and
introducing at least one semi-frozen slurry into the lid space.

14. A method as set forth in claim 12, further comprising the steps of;
inserting the separator in the container space wherein it supports itself in an upright position, wherein the separator extends above the top rim of the cup and includes a top edge and a tab extending upward from the top edge,
filling the first compartment with the first semi-frozen slurry having the first color,
filling the second compartment with the second semi-frozen slurry having the second color,
fitting the lid over the separator to form lid space above the container space, and so that the tab of the separator extends through a single straw hole in the lid,
moving the tab within the straw hole to make a flow path to a certain region of the lid space and introducing a semi-frozen slurry to this region, and
moving the tab within the straw hole to make flow path into another region of the lid space and introducing a semi-frozen slurry to this other region.

15. A multi-color slurry beverage comprising the multi-color slurry beverage set forth in claim 1 with the separator removed, wherein the first semi-frozen slurry still substantially occupies only the first compartment and wherein the second semi-frozen slurry still substantially occupies only the second compartment.

16. A multi-color slurry beverage as set forth in claim 1, wherein the separator separates the container space into the first compartment, the second compartment, a third compartment, and a fourth compartment;
wherein the third compartment is filled with a third semi-frozen slurry having a third color; and
wherein the fourth compartment is filled with a fourth semi-frozen slurry having a fourth color.

17. A multi-color slurry beverage as set forth in claim 16, wherein the third color is visually distinguishable from the first color, and the second color.

18. A multi-color slurry beverage as set forth in claim 17, wherein the fourth color is visually distinguishable from the first color, the second color, and the third color.

19. A multi-color slurry beverage comprising the slurry beverage set forth in claim 16 with the separator removed, wherein the first semi-frozen slurry still substantially occupies only the first compartment, the second semi-frozen slurry still substantially occupies only the second compartment, the third semi-frozen slurry still substantially occupies only the third compartment, and the fourth semi-frozen slurry still substantially occupies only the fourth compartment.

20. A slurry beverage comprising:
a cup having a floor and a top rim, wherein a container space is defined by the cup;
a separator disposed within the container space, wherein the separator separates the container space into a first compartment and a second compartment;
wherein the first compartment and the second compartment each extend from the cup's floor to a top rim of the cup.
